(19) United States
(12) Patent Application Publication
(10) Pub. No.: US 2026/0230487 A1
(43) Pub. Date: Aug. 6, 2026

(54) SYSTEMS AND METHODS FOR DETECTING ANOMALIES IN SILOED NETWORKS

(71) Applicant: Dark Watch, Stuart, FL (US)

(72) Inventors: Noel Thomas, Stuart, FL (US); James Snay, Stuart, FL (US)

(73) Assignee: Dark Watch, Stuart, FL (US)

(21) Appl. No.: 19/576,997

(22) Filed: Mar. 24, 2026

Related U.S. Application Data
(63) Continuation-in-part of application No. 19/009,884, filed on Jan. 3, 2025, now Pat. No. 12,585,713.

(51) Int. Cl. H04L 9/40

(52) U.S. Cl. CPC H04L 63/1425; H04L 63/1416

(57) ABSTRACT

Systems and methods for uses and/or improvements to data scraping and/or data collection applications. As one example, systems and methods for web scraping applications that overcome multi-layered encryptions, content nesting, and/or other techniques for frustrating web scraping systems. For example, some websites, particularly those used in human trafficking, fraud, and/or other criminal enterprises, employ various encryption and/or encoding techniques to obstruct and frustrate web scraping systems, aiming to hide their data.

### CROSS-REFERENCE TO RELATED APPLICATION

This application is a continuation-in-part of U.S. Patent Application No. 19/009,884, filed January 3, 2025. The content of the foregoing application is incorporated herein in its entirety by reference.

### BACKGROUND

Real-time detection of threat-vector activities (e.g., terrorism, human trafficking, organized crime, illicit finance, fraud, child exploitation, synthetic identity networks, and/or geospatial anomaly patterns) is extraordinarily difficult because these behaviors are deliberately designed to avoid visibility, operate across fragmented systems, and mimic legitimate patterns. Threat actors constantly adapt, changing their tactics, communication channels, and operational signatures faster than traditional monitoring systems can update. Many activities, e.g., such as terrorism financing, human trafficking logistics, or synthetic identity fraud, blend seamlessly into the massive volume of normal digital, financial, and geospatial activity generated every second. This creates an extreme signal-to-noise imbalance in which meaningful anomalies are buried inside billions of routine transactions and movements.

Compounding this challenge, critical data is spread across siloed networks, jurisdictions, and institutions that often cannot share information in real time due to privacy, regulatory, or technical constraints. Threats such as organized crime or child exploitation also exploit encrypted platforms, decentralized communication tools, and cross-border infrastructures that obscure their true origin and intent. Machine-learning and analytic systems can help, but even advanced models struggle when adversaries deliberately craft behaviors to evade detection, or when there is limited labeled data on rare, evolving threat types. Geospatial anomalies, for instance, may require fusing disparate sensor, satellite, mobility, and behavioral datasets, e.g., each with its own latency, noise, and uncertainty. Together, these factors make real-time identification of complex threat vectors both technologically demanding and operationally fragile, requiring continuous refinement, multi-domain data fusion, and human-machine collaboration to be effective.

### SUMMARY

Systems and methods are described herein for systems and methods for detecting anomalies in siloed networks featuring extreme signal-to-noise imbalances using point-of-contact based filtering criteria for data processing and data retrieval. For example, the system may detect anomalies in siloed networks with extreme signal-to-noise imbalance can use point-of-contact–based filtering criteria to dynamically shape both data processing and data retrieval. By anchoring analysis to specific point-of-contact characteristics (e.g., business type, geography, entity role, payment method, or channel of interaction), the system can determine which normalization routines, feature-extraction processes, and comparison baselines are most relevant for a given data fragment. This targeted routing prevents the system from applying broad, high-volume analytic workflows to every input, reducing noise and enabling more precise pattern recognition. For instance, data from a high-risk merchant category might trigger enhanced enrichment routines, additional behavioral comparisons, or tighter thresholding, while data from a low-risk category might flow through lighter-weight processing.

In parallel, point-of-contact characteristics guide the system’s retrieval of external or cross-network reference data, allowing it to selectively pull information from disparate, otherwise siloed datasets that are pertinent to that specific interaction. Instead of querying all sources blindly, the system computes which networks, histories, or contextual datasets are most informative (e.g., regional mobility patterns, industry-specific fraud baselines, or location-linked risk signals), thereby enabling cross-referencing that would not occur naturally. Together, this adaptive processing and selective retrieval approach mitigates noise, heightens sensitivity to subtle anomalies, and allows the system to surface meaningful irregularities that would otherwise be obscured in fragmented, high-volume data environments.

As an example, a point-of-contact–driven system for anomaly detection can be applied to threat vectors by using contextual cues at the moment of interaction to decide how aggressively data should be analyzed and what external networks should be cross-referenced. Because threat-vector activities (e.g., terrorism financing, human trafficking logistics, organized crime movements, or online child-exploitation behaviors) tend to hide inside massive volumes of legitimate activity, tying analytic decisions to specific point-of-contact characteristics allows the system to amplify faint risk signals without overwhelming itself with noise. For example, if a transaction originates from a business type historically associated with cash-intensive illicit finance, the system can trigger enhanced processing: deeper pattern-matching against typologies, additional entity-resolution checks, and cross-network comparisons to dark-web marketplace indicators or high-risk financial-flow clusters. In a mobility-based context, if a user’s geospatial point of contact corresponds to known trafficking corridors or unusual border-proximate transit nodes, the system can dynamically pull in specialized geospatial baselines, compare movement profiles against regional anomaly models, and elevate scrutiny for route irregularities. Likewise, for synthetic identity networks, point-of-contact metadata such as device type, onboarding channel, or document-submission source can cue the system to retrieve siloed datasets (e.g., compromised-identity repositories, velocity checks across multiple institutions, or prior fraud-attempt signatures) enabling cross-institution linkage that would not occur passively. By tailoring both the intensity of data processing and the selection of external reference networks to the specific context of each interaction, the system becomes capable of surfacing subtle, cross-domain anomalies indicative of threat-vector activity while avoiding the computational overload and high false-positive rates that plague traditional, broadly applied detection methods.

Unfortunately, applying point-of-contact–based filtering to detect anomalies in noisy, siloed networks may raise a novel technical challenge: translating highly contextual, dynamically generated anomaly signals into clear, real-time assessments of severity that can be understood immediately at the point of contact. Because the system tailors its processing pathways and data-retrieval sources to each interaction, the anomalies it identifies are inherently shaped by specialized routines, localized baselines, and domain-specific comparisons. This creates a situation in which the same statistical deviation may imply vastly different levels of risk depending on the business type, geography, entity role, or channel that governed its analytic path. To issue actionable alerts, the system must therefore reconstruct and explain why an anomaly matters (e.g., bridging the gap between complex, heterogeneous analytics and the need for simple, or timely signals at the moment of decision). For example, an irregular financial pattern detected for a high-risk merchant category and validated through cross-network comparisons may warrant an immediate intervention, but the system must express this elevated severity without requiring the operator to interpret multiple datasets or understand the underlying enrichment logic. Similarly, a geospatial anomaly flagged along a known trafficking corridor must be framed in context (e.g., highlighting the risk factors that influenced the score) while avoiding false urgency in low-risk scenarios that may trigger the same detection routines. Balancing this richness and interpretability in real time is technically challenging: the system must synthesize diverse contextual cues, normalize severity across disparate threat domains, and present a concise, intelligible explanation that reflects both the anomaly’s origin and its operational implications.

The system can overcome this challenge by generating a dynamic threat identifier that evolves as the data passes through context-specific processing and retrieval routines. Initially, the system assigns the threat identifier a baseline profile derived from the point-of-contact characteristic (e.g., merchant type, device class, location, or transaction channel), which establishes the contextual frame through which any anomaly should be interpreted. As the system processes the data, each analytic step (e.g., entity-resolution checks, domain-specific normalization, cross-network comparisons, or geospatial pattern matching) contributes incremental, weighted adjustments to the identifier’s attributes. These adjustments reflect not only the presence of anomalies but also the significance of those anomalies given the processing logic that surfaced them. For instance, an anomaly detected only after pulling data from a high-risk external dataset may add more weight than an anomaly found through routine checks. Over time, the threat identifier becomes a synthesized, compact representation of the anomaly’s context, severity, and provenance. Because its characteristics are iteratively shaped by the exact analytic pathways used, the resulting identifier provides an intuitive, real-time signal, e.g., such as a cumulative score, qualitative label, or risk tier, that communicates threat significance without exposing the operator to the underlying complexity. This approach transforms heterogeneous analytic outputs into a coherent and easy-to-interpret artifact that supports rapid decision-making at the point of contact.

In some aspects, systems and methods for detecting anomalies in siloed networks featuring extreme signal-to-noise imbalances using point-of-contact based filtering criteria for data processing and data retrieval are described. For example, the system may receive point-of-contact data at a first location. The system may calculate a potential threat vector based on the first location, wherein the potential threat vector has a first characteristic. The system may calculate a point-of-contact characteristic in the point-of-contact data. The system may, based on the point-of-contact characteristic, select a first processing routine, from a plurality of processing routines, or a first data retrieval routine, from a plurality of data retrieval routines, for the point-of-contact data. The system may process the point-of-contact data using the first processing routine or the first data retrieval routine. The system may generate a second characteristic for the potential threat vector by modifying the first characteristic based on processing the point-of-contact data using the first processing routine or the first data retrieval routine. The system may generate for display, on a user interface, the potential threat vector with the second characteristic.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIGS. 1A-G show illustrative diagrams for detecting anomalies in siloed networks via user interfaces, in accordance with one or more embodiments.

FIGS. 2A-C show illustrative pseudocode for selecting one or more processing and/or data retrieval routines for point-of-contact data, in accordance with one or more embodiments.

FIG. 3 shows illustrative components for a system used to perform a bifurcated data extraction routine, in accordance with one or more embodiments.

FIG. 4 shows illustrative steps for data collection from encrypted content sources comprising multi-layered encryptions and nested content, in accordance with one or more embodiments.

FIG. 5 shows an illustrative diagram showing the parsing of data elements, in accordance with one or more embodiments.

FIG. 6 shows illustrative steps for detecting anomalies in siloed networks, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

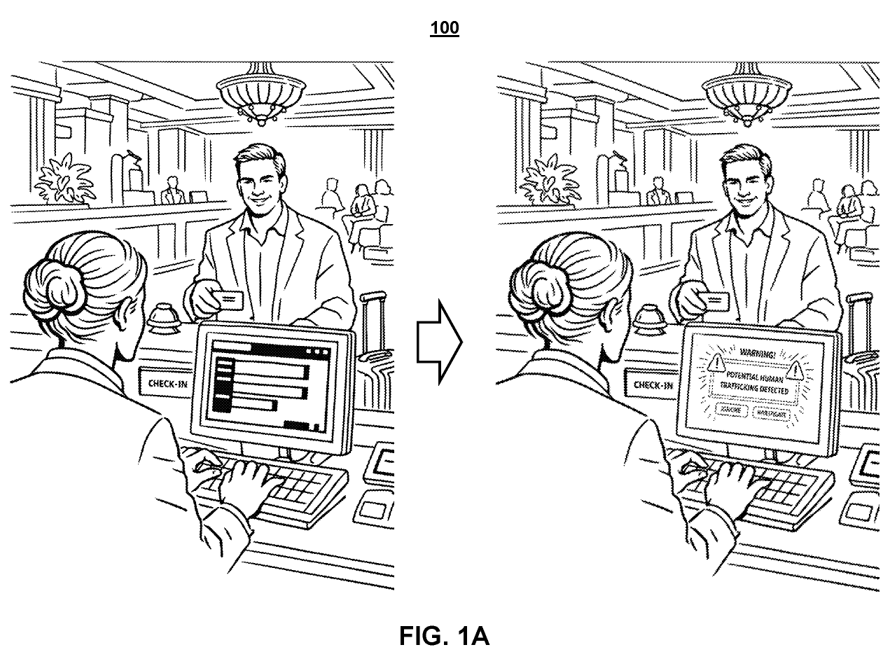

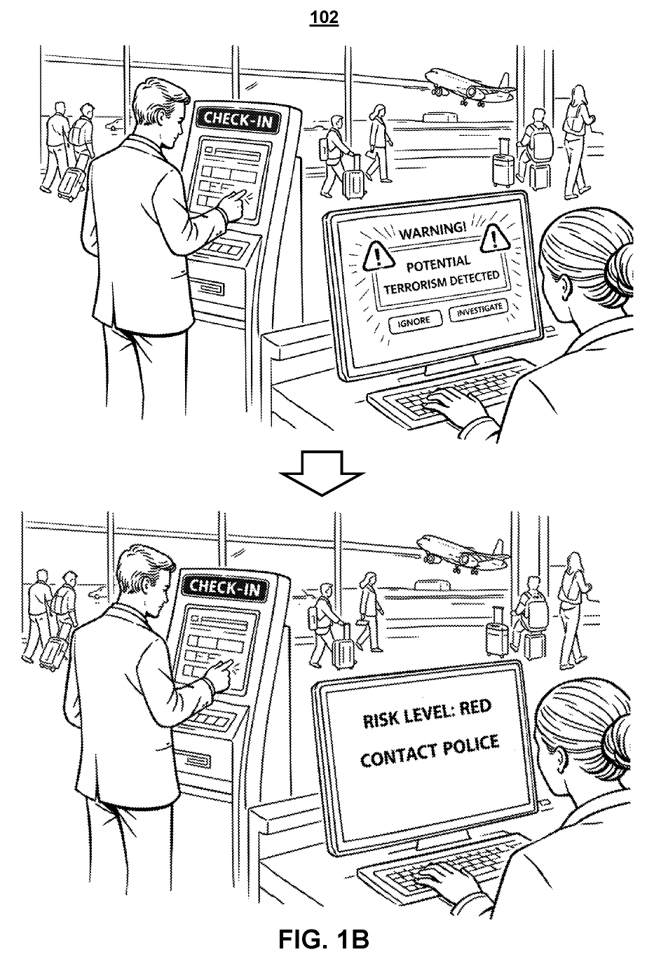

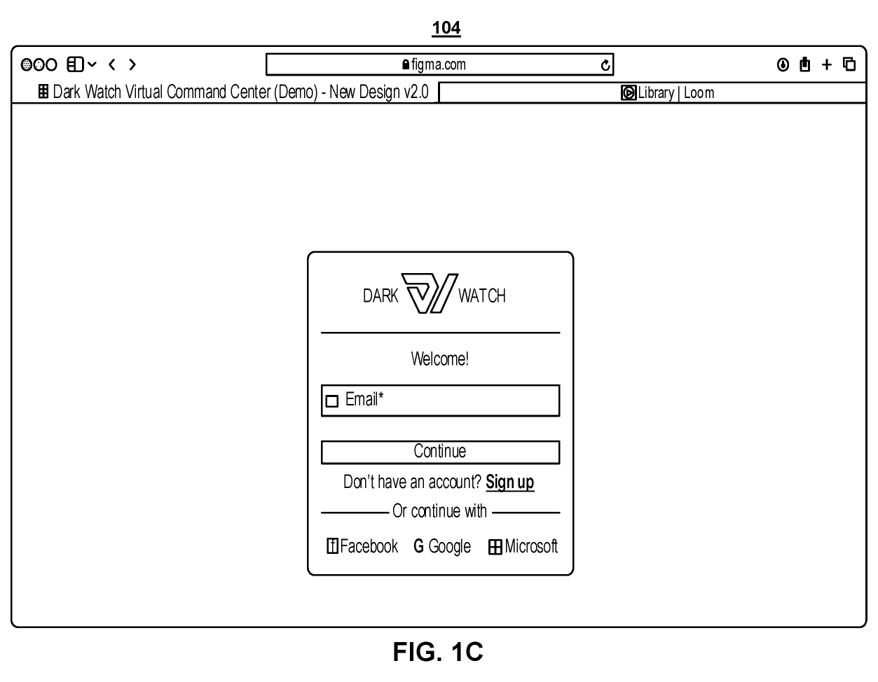

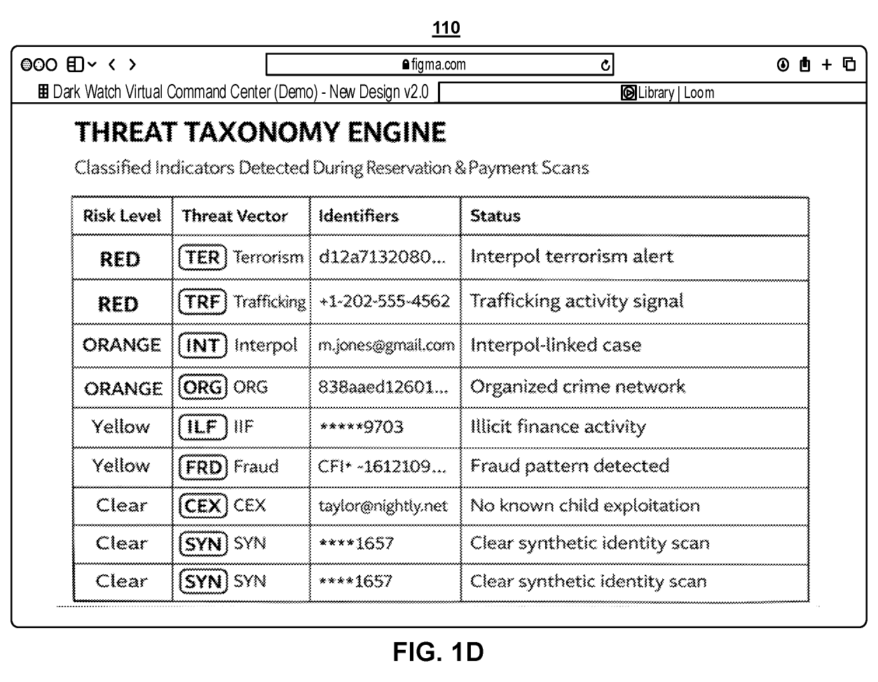

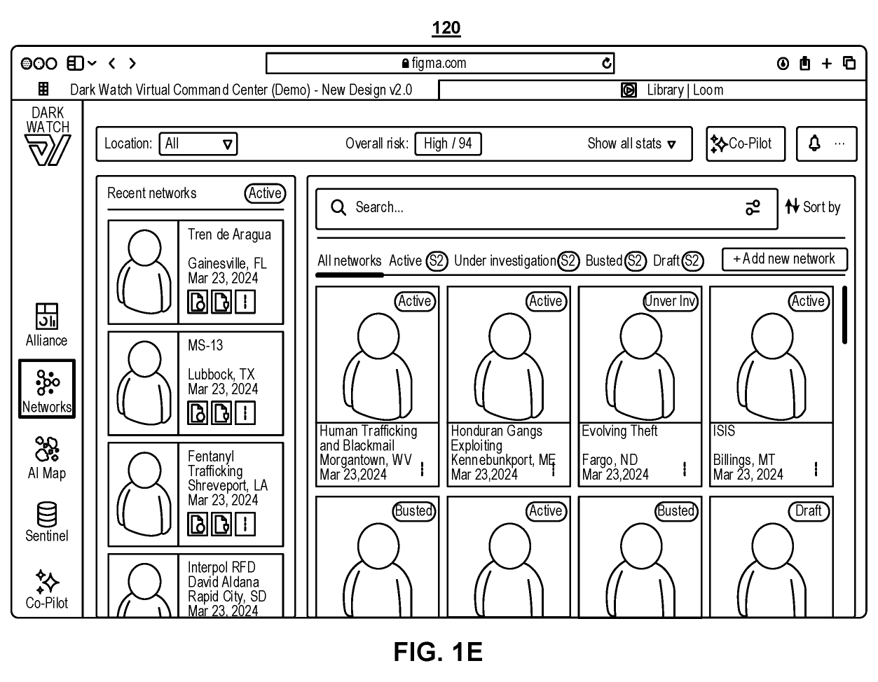

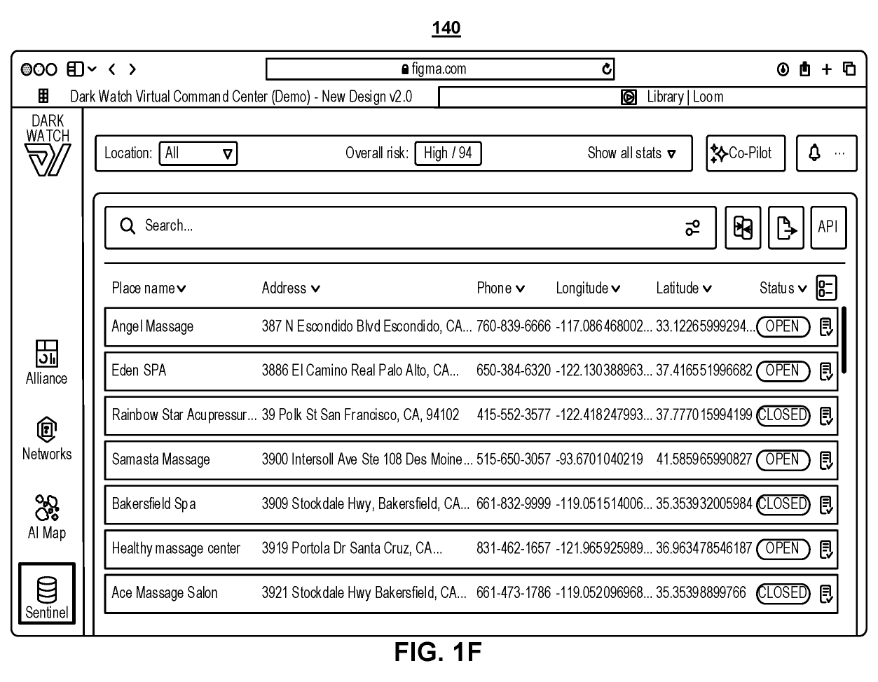

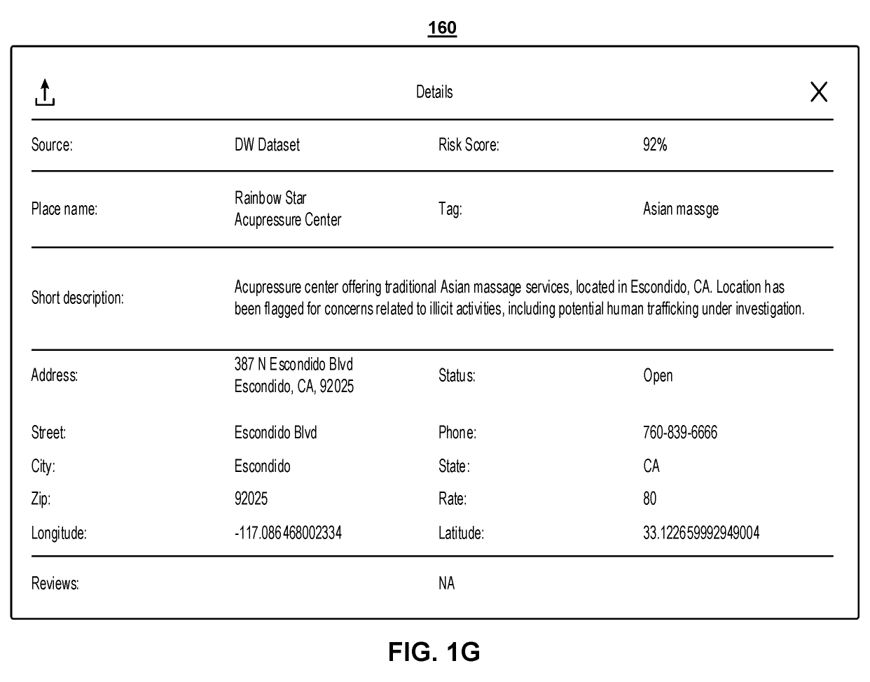

FIGS. 1A-E show illustrative diagrams for detecting anomalies in siloed networks via user interfaces, in accordance with one or more embodiments. For example, FIG. 1A shows an illustrative diagram (e.g., diagram 100), which implements a system for detecting anomalies (e.g., anomalies indicative of threat-vector activities) in siloed networks (e.g., a hotel check-in process) featuring extreme signal-to-noise imbalances using point-of-contact based filtering criteria for data processing and data retrieval. For example, the system may use specific point-of-contact characteristics (e.g., business type, geography, entity role, payment method, or channel of interaction), to select a processing routine and determine whether to generate a dynamic threat identifier for the potential threat vector.

For example, FIG. 1A presents diagram 100 within the context of a hotel check in scene in which a front desk agent interacts with a guest while viewing a computer screen. The system may receive point-of-contact data while the guest provides a payment card, representing a typical siloed transaction flow before anomaly analysis occurs. Subsequently, the same check in interaction is augmented by the system by an anomaly detection system. In this state, the user interface has transitioned to a warning screen that highlights a detected threat condition associated with the transaction using prominent alert graphics and explanatory text. This progression visually conveys how the system can monitor high noise point of contact environments such as hotel front desks, apply point of contact based filtering criteria to the reservation or payment data in real time, and surface a dynamic threat identifier on the same operational screen when anomalous or high risk behavior consistent with a threat vector is detected.

For example, in FIG. 1A, the system operates through a user terminal at a point of contact such as a hotel front desk, where it first receives point of contact data that may include reservation details, guest identity attributes, payment credentials, and device information associated with a particular check in. Point-of-contact data may comprise the information that is created, captured, or observed at the moment an entity interacts with a system or service. This can include identity related attributes such as a name, account number, username, loyalty identifier, or partially redacted government document information, along with communication details such as phone numbers, email addresses, or messaging handles. It may also include transaction and session details, for example payment method, card type, issuing country, purchase amount, time of day, channel of interaction, device identifiers, browser fingerprints, or application version. Environmental and contextual elements can be part of point of contact data as well, such as the geographic position of the terminal, the type of location or business, network attributes like IP address and routing path, and behavioral signals such as click patterns, keystroke timing, or prior visit history. Together, these elements form a contextual snapshot of the interaction that can be analyzed to detect anomalies or patterns associated with potential threat vectors.

A location may comprise a specific physical or virtual setting in which an interaction or transaction occurs, together with descriptive attributes that characterize that setting. In a physical sense, a location can include a geographic position such as coordinates, address, city, region, or country, as well as a location type such as hotel, stadium, airport, retail store, financial branch, or border checkpoint. It may further include details about the venue layout or zone, for example lobby, guest floor, gate area, or restricted access room, and operational attributes like hours of operation or local regulatory regime. In a digital or hybrid context, a location can also comprise logical indicators such as an IP address range, domain, application environment, or virtual tenant space that tie an interaction to a particular network segment or service context. Together, these physical and logical elements define the environment in which point of contact data is generated and provide the contextual basis for selecting relevant threat vectors, baselines, and processing routines.

A location type may comprise a categorical description of the environment in which an interaction occurs, used to group similar venues or channels for analytic and risk assessment purposes. It can identify the primary function of the site, such as hotel, short term rental, casino, stadium, airport, seaport, retail store, financial branch, data center, warehouse, or online marketplace. A location type may also reflect operational characteristics, for example whether the venue is public facing, restricted access, transit oriented, residential, or industrial, and whether activity at the site is primarily lodging, payments, entertainment, logistics, or customer onboarding. In some implementations, a location type further includes regulatory or jurisdictional attributes, such as classification as a high value payment node, a critical infrastructure facility, or a cross border checkpoint. By assigning a location to one or more location types, the system can apply appropriate baselines, select relevant potential threat vectors, and determine which specialized processing or retrieval routines should be used when evaluating point of contact data generated at that site.

The terminal may be associated with a specific geographic position and a defined location type, for example a hotel in a particular city, and this context is used to select one or more potential threat vectors from a plurality of available vectors and to assign each selected vector an initial severity characteristic that reflects baseline risk for that combination of geography and business environment. A geographic position may comprise information that specifies where an interaction or asset is located on the earth, expressed with sufficient precision to support analysis and correlation across datasets. It can include latitude and longitude coordinates, altitude or floor level, and an associated accuracy or confidence value derived from the underlying positioning technology. A geographic position may also comprise derived descriptors such as country, region, city, postal code, or neighborhood, as well as map based references like geohash cells, grid identifiers, or proximity to known landmarks, borders, or transportation hubs. In some implementations, it further includes the source of the location data, for example GPS, cellular triangulation, Wi Fi positioning, fixed sensor infrastructure, or manually entered address information. Together, these elements provide a structured representation of physical placement that the system can use to classify locations, identify membership in high risk zones or corridors, and select appropriate baselines and threat vectors for processing point of contact data.

A geographic position type may comprise a classification that describes the nature or role of a particular geographic position rather than its exact coordinates. It can indicate whether the position corresponds to an urban core, suburban area, rural region, border zone, transportation corridor, tourism district, residential neighborhood, industrial park, or critical infrastructure site. A geographic position type may also capture regulatory or operational status, such as free trade zone, high security area, high crime district, disaster affected region, or demilitarized zone. In some implementations, it further characterizes typical activity patterns at that position, for example whether it is primarily associated with commuter traffic, freight movement, nightlife, financial services, or temporary events. By assigning a geographic position to one or more geographic position types, the system can apply context specific baselines, prioritize certain threat vectors, and tune processing or retrieval routines to the risk profile associated with that category of place.

A potential threat vector may comprise a structured representation of a category of harmful or illicit activity that the system monitors for within point of contact interactions. It can define a specific domain of risk such as terrorism, human trafficking, organized crime, illicit finance, fraud, child exploitation, synthetic identity networks, or geospatial anomaly patterns, together with the behavioral, transactional, and geospatial signatures associated with that domain. A potential threat vector may include typologies, example scenarios, baseline statistics, and feature sets that describe how the activity tends to appear across different data sources, as well as parameters for how anomalies related to that vector should be scored or weighted. In some implementations, it also comprises configuration data such as default severity levels by location type or geography, links to external reference datasets, and rules that govern when alerts should be generated or escalated. By modeling each category of risk as a potential threat vector, the system can tailor its analysis, select appropriate processing routines, and express results as a coherent severity assessment for that specific kind of threat.

An initial severity characteristic may comprise a baseline assessment of risk associated with a potential threat vector before detailed analysis of the current point of contact data has been completed. It can include a numeric score, qualitative tier, or categorical label that reflects historical risk patterns for the relevant geographic position, location type, and threat domain, for example low, medium, or high. This characteristic may be derived from preconfigured rules, statistical baselines, prior incident history, regulatory designations, or customer specific risk appetites. In some implementations, the initial severity characteristic also comprises weighting parameters or thresholds that determine how strongly subsequent analytic outputs will influence the final severity evaluation, as well as metadata describing why the baseline level was assigned, such as association with a high risk corridor or a low risk merchant category. Together, these elements provide a starting context that frames how the system interprets anomalies and guides the selection and tuning of processing and retrieval routines for the potential threat vector.

The system may then analyze the incoming point of contact data to calculate one or more point of contact characteristics, such as the type of payment method presented, the duration and timing of the stay, the role of the entity involved, or patterns in prior visits. A point of contact characteristic may comprise a feature or attribute derived from the data associated with a specific interaction that captures something meaningful about how, where, or by whom that interaction is taking place. It can include operational details such as business type, merchant category, check in versus checkout status, payment method, currency, device class, or communication channel. It may also encompass behavioral measures like transaction velocity, time of day patterns, stay duration, or deviations from a customer’s historical profile, as well as environmental attributes including the geographic position of the terminal, the location type, or the network context in which the interaction occurs. In some implementations, a point of contact characteristic further comprises composite indicators such as risk scores, role classifications, or flags derived from prior interactions at the same venue or with the same entity. These characteristics provide the basis for routing data through appropriate processing routines or retrieval routines so that analysis is tuned to the specific context of the interaction.

A processing routine may comprise a defined sequence of computational steps that the system applies to point of contact data in order to transform, enrich, or analyze it for anomalies related to potential threat vectors. It can include operations such as data cleaning, normalization, and formatting, as well as feature extraction that derives structured indicators from raw inputs, for example calculating transaction velocities, geospatial movement patterns, or device reuse metrics. A processing routine may also comprise analytic algorithms such as statistical deviation checks, machine learning models, rules based pattern matching, graph analysis for network relationships, or entity resolution procedures that link related identifiers across records. In some implementations, the routine further defines configuration parameters, thresholds, and weighting logic that determine how its outputs contribute to severity assessments, along with logging or explainability metadata that records how the data was handled. By organizing these steps into reusable processing routines, the system can selectively apply different analytic pathways based on point of contact characteristics and threat vector requirements.

A data retrieval routine may comprise a set of instructions that govern how the system queries and acquires external or cross network information relevant to a particular point of contact interaction. It can specify which remote databases, partner systems, sensor networks, or open source feeds should be contacted based on the interaction’s characteristics, along with the query parameters, filters, and access credentials needed to obtain the data. A data retrieval routine may also include logic for resolving identifiers across systems, such as mapping device fingerprints, payment tokens, or partial identity attributes to equivalent records in other networks, and can define constraints on latency, privacy, and data minimization to ensure that only necessary fields are returned. In some implementations, the routine further comprises post retrieval steps such as caching, deduplication, and basic validation of the returned records so that they can be safely combined with local data and passed into downstream processing routines. Based on these calculated characteristics, the system dynamically selects one or more processing routines or one or more data retrieval routines from corresponding libraries. The selected processing routines may include normalization, pattern matching, or behavioral scoring, while the selected retrieval routines may call out to siloed external datasets or cross network reference sources that are relevant for that specific interaction. The point of contact data is processed through these routines to generate one or more outputs, such as anomaly scores, matched typologies, or contextual risk signals. The system then updates the severity characteristic for the applicable threat vector by weighing these outputs according to which processing or retrieval routines produced them, so that results from higher confidence or higher sensitivity analyses exert greater influence on the final evaluation. This produces a final severity characteristic that reflects both the baseline risk and the evidence gathered during targeted analysis.

A final severity characteristic may comprise a synthesized assessment of risk for a potential threat vector after the system has completed context specific processing and data retrieval for a given interaction. It can include a refined score, tier, or label that results from adjusting the initial severity characteristic using weighted outputs from one or more processing routines and data retrieval routines. This characteristic may capture both the magnitude and confidence of detected anomalies, taking into account which analytic pathways produced them, how strong the deviations were from relevant baselines, and whether corroborating evidence was found across siloed networks. In some implementations, the final severity characteristic also comprises explanatory metadata such as contributing factors, threshold crossings, or references to typologies that were matched, so that operators can understand why the risk level was elevated or reduced. Together, these elements provide a concise yet comprehensive representation of the current threat posture for that vector, suitable for direct presentation alongside a dynamic threat identifier at the point of contact.

The system then generates for display on the user terminal a dynamic threat identifier for the potential threat vector, presented together with the final severity characteristic, so that the front desk agent sees a clear, real time warning or confirmation of elevated risk directly within the operational check in interface. A dynamic threat identifier may comprise a compact, evolving representation of the risk associated with a potential threat vector for a specific interaction, suitable for real time display at the point of contact. It can include a machine generated label, icon, or code that uniquely references the threat vector, along with an associated severity indication such as a score, color state, or risk tier that reflects the current final severity characteristic. The identifier may further comprise structured attributes that summarize the analytic path that produced it, for example which processing routines or data retrieval routines contributed, timestamps of key evaluation steps, and links to underlying evidence or typologies. In some implementations, it also includes contextual tags such as location type, geographic position type, or channel of interaction, which help operators interpret the alert in operational terms. Because the identifier is updated as additional data is processed or new reference information is retrieved, it provides a living artifact that tracks how the system’s assessment of a threat vector changes over time while remaining simple enough to guide immediate decision making.

FIG. 1B shows diagram 102, which illustrates an airport check in scenario in which a self-service kiosk and a remote monitoring workstation are linked by an anomaly detection system. As shown, a traveler interacts with a check in kiosk while, in the background, other passengers move through the terminal and an aircraft is visible on the tarmac, indicating a busy, high noise environment. At the same time, an operator at a nearby workstation views a display that presents a prominent warning message stating that a potential terrorism related threat has been detected, along with options to ignore or investigate the alert. The system then updates the operator’s display to show a simplified decision oriented message that indicates a red risk level and instructs the operator to contact police. Diagram 102 demonstrates how the system can convert complex, real time analysis of point of contact data captured at the kiosk into a clear dynamic threat identifier and an actionable severity assessment presented to personnel responsible for responding to potential threat vector activity.

In diagram 102, the system may employ a dynamic, multi-layer threat taxonomy engine that continuously evaluates reservation and payment activity associated with the airport check in kiosk and linked back office systems. As a traveler enters information and submits a payment, the engine ingests high risk behavioral indicators such as device fingerprints, phone numbers, email addresses, ticketing details, and masked payment credentials and normalizes them into a standardized internal format. Each indicator is compared against a taxonomy of potential threat vectors, where terrorism, human trafficking, organized crime, illicit finance, fraud, child exploitation, synthetic identity networks, and geospatial anomaly patterns are each represented by a universal three letter code such as TER, TRF, INT, or ORG. For every vector, the engine assigns one of four canonical color signatures, with Red representing a severe state, Orange representing an elevated state, Yellow representing a cautionary state, and Clear representing an absence of known indicators. As matches and correlations are found, the system resolves overlapping signals into a single reproducible color state for the relevant codes and forwards only these coded and colorized outputs to the operator’s display, avoiding any need to present or store underlying personal identifiers. In the illustrated example, the fusion of kiosk level indicators produces a TER coded Red state, which is rendered on the monitoring screen as a clear dynamic threat identifier and an instruction to treat the interaction as a severe terrorism related risk.

For example, diagram 102 shows the executing of a processing routine. For example, within the threat taxonomy engine, each threat category is organized into structured sub types that inherit properties from their parent category while adding more specific rules, feature sets, and default sensitivities. Inheritance rules allow shared behaviors, such as common payment typologies or movement patterns, to propagate from a parent category to all of its sub types so that updates can be applied consistently without redefining every variant. Temporal decay logic is applied to indicators within each sub type so that older, unresolved signals gradually lose influence on the assessed severity unless they are refreshed by new corroborating events, which prevents stale data from keeping a risk state artificially high. When a single interaction triggers indicators in multiple categories, for example a TRF coded trafficking sub type and an ORG coded organized crime sub type, the engine performs cross category blending that combines their respective color states into a composite profile; in this case an Orange trafficking signal and a Yellow organized crime signal may resolve into an elevated Orange overall assessment that reflects both influences. In some embodiments, the system can configure bespoke weighting schemes that adjust how strongly each category and sub type contributes to the composite, allowing a stadium operator to emphasize TER coded terrorism risks or a hotel group to give higher sensitivity to TRF coded trafficking indicators. A fusion layer may receive these weighted signals from different business lines and technology stacks, reconciles them into a single consistent representation, and outputs an updated threat posture in milliseconds across hospitality, gaming, payments, logistics, and security platforms. Through this design, every risk signal is ultimately expressed as a three letter code paired with one of four color states, providing a universal, interoperable language that standardizes how complex, real world threats are classified and communicated.

FIGS. 1C-G show illustrative diagrams for a user interface accessing a secured session and accessing secured data, in accordance with one or more embodiments. For example, FIGS. 1C-G may represent user interfaces that present additional data after a secured session is established. For example, FIG. 1C illustrates a user interface (e.g., user interface 104) designed as a portal for accessing a system that facilitates specific functions. A user interface (UI) is a graphical or interactive component of a software application that enables users to communicate with a system. It typically includes visual elements such as menus, buttons, text fields, and dashboards, as well as input mechanisms like keyboards, mice, touchscreens, or voice commands. Users access and interact with the UI through devices such as computers, smartphones, or tablets, using these input methods to navigate the interface, execute commands, and retrieve information.

In some embodiments, systems and methods are described herein for novel uses and/or improvements to data scraping and/or data collection applications. For example, web scraping is the process of automatically extracting information from websites using software tools or scripts. It involves sending a request to a web page, retrieving its content, e.g., typically in HTML or another structured format, and then parsing the data to extract specific information, such as text, images, or other elements. Web scraping is highly beneficial because it allows organizations, researchers, and businesses to gather and analyze large amounts of publicly available data efficiently. However, some websites, particularly those facilitating illicit activities such as human trafficking, fraud, or other criminal enterprises, actively resist data collection to avoid scrutiny and detection using data encryptions. These websites may fear exposure, as scraping could allow law enforcement agencies, activists, or researchers to uncover illegal activities, identify patterns, and trace individuals involved. By frustrating scraping efforts, such websites attempt to maintain anonymity and reduce the risk of being held accountable.

Data encryption is the process of transforming data into a secure format that prevents unauthorized access or understanding. This may comprise converting it into ciphertext using cryptographic algorithms such that only authorized users with the correct decryption key can access the original data. Alternatively, or additionally, this may include data obfuscation techniques, such as masking, which involves partially or completely replacing sensitive data with altered or dummy values while retaining its structure and usability for specific purposes.

As one example, systems and methods are described herein for data scraping applications that overcome multi-layered encryptions, content nesting, and/or other techniques for frustrating web scraping systems. For example, some websites, particularly those used in human trafficking, fraud, and/or other criminal enterprises, employ various encryption and/or encoding techniques to obstruct and frustrate web scraping systems, aiming to hide their data.

These websites may use sophisticated tools or techniques to make scraping data more complex and/or impossible. For example, websites may use mechanisms such as CAPTCHAs, which challenge automated bots with puzzles that are easy for humans but difficult for machines to solve. Additionally, as web scraping is often a time-dependent process, websites may monitor the frequency and pattern of requests, blocking IP addresses that exhibit suspicious behavior indicative of bots, such as sending too many requests in a short time. These websites may also use dynamic content loading, where key data is only rendered in the browser after specific actions, making it harder to scrape in one pass. As another example, websites may implement anti-scraping headers and token-based authentication systems, requiring valid session tokens for accessing content, the expiration of which may prevent a thorough review of the website and/or allow for scraping of dynamic and time-based content. Finally, websites may use data obfuscation, such as encoding or encrypting content, and serve different versions of the website to users and suspected bots.

Each of these measures adds to the complexity and additional time pressure to web scraping. For example, even if content can be successfully detected and decrypted, the detection and decryption themselves create time pressures for successfully scraping the data. Moreover, in many instances, these techniques may be embedded within each other such that one encryption used to frustrate web scraping may be nested inside another. Thus, even if one mechanism is overcome, additional mechanisms may still prevent the data collection.

To overcome these technical hurdles in data scraping and/or data collection, the systems and methods use a bifurcated data extraction routine that includes an initial analysis and tagging routine prior to a dynamically selected extraction routine. More specifically, the first routine of the bifurcated scrapping routine may parse websites (or other content) and tag relevant data to map the website. Once the website is mapped, the system may determine, based on characteristics of the relevant data, one or more functions (and an order of execution) for extracting the relevant data. By first generating the map of relevant data, the system may determine what data to scrape, what function to use to successfully scrape the data, and how to do so both efficiently and precisely.

In some aspects, systems and methods for data scraping encrypted content sources comprising multi-layered encryptions and nested content are described. For example, the system may retrieve a first content source, wherein the first content source comprises a plurality of encrypted content masked by one or more of a plurality of data encryption types. The system may execute a first routine, of a bifurcated data extraction routine, on the first content source to determine a first data encryption type for first encrypted content in the first content source. The system may execute a second routine, of the bifurcated data extraction routine, to select a first extraction function, from a plurality of extraction functions, based on the first data encryption type. The system may generate first non-encrypted content based on applying the first extraction function to the first encrypted content. The system may generate for display, on a user interface, the first non-encrypted content.

In the context of FIG. 1C, the system may be described is a proprietary scraping and/or data aggregation tool that operates by combing illicit data from the web. The tool aggregates this information into a centralized data lake, organizing it for efficient retrieval and integration. The user interface simplifies the process of importing this data into native systems or core platforms used for account and transaction monitoring. By presenting the scraped and aggregated data in an accessible format, the UI facilitates streamlined workflows, allowing users to identify, analyze, and act on suspicious or relevant information effectively within their monitoring systems.

In some embodiments, the data scraping and collection tool can be adapted to extract information from a variety of data sources beyond the Internet, including structured databases, unstructured file systems, and proprietary platforms. To scrape other databases, the tool can be configured to connect directly to database systems via APIs, SQL queries, or other integration methods, depending on the database architecture. For relational databases, the tool might utilize structured query language (SQL) to retrieve data from tables based on defined criteria. In the case of NoSQL databases, it can leverage their specific query mechanisms, such as aggregation frameworks or search queries, to extract relevant information.

For proprietary or closed systems, the tool may employ automated processes like screen scraping, direct API integrations, or data exports facilitated by the host system. Additionally, it can work with file-based storage systems, parsing data from formats such as CSV, XML, JSON, or log files. In these contexts, the tool’s adaptability lies in its ability to interface with multiple protocols, transform raw data into a structured format, and aggregate the results into its centralized data lake. This flexibility makes it a versatile solution for collecting and consolidating information from disparate sources, supporting robust data analysis and integration into core systems.

As described herein, systems and methods may relate to data scraping applications that overcome multi-layered encryptions, content nesting, and/or other techniques for frustrating data scraping systems. As referred to in, encrypted content and/or obfuscated content (which may be referred to collectively) may refer to any content that is not collectable or able to be processed in its native form. For example, encrypted content and/or obfuscated content may refer to content in which its native form is prevented from collection based on key encryptions, content nesting, and/or other techniques used to frustrate data collection and/or processing systems. It should also be noted that as described herein, embodiments describing “encrypted content” may be referred to interchangeably with “obstructed content.” That is, the systems and methods described herein may be applied to collect data despite the one or more mechanisms used to prevent that collection.

As shown in FIG. 1C, user interface 104 may be used by the system to receive a first user request to begin a secured session. The system may then authenticate the secured session. In response to authenticating the secured session, the system may retrieve a first content source (e.g., a website, a database, etc.). For example, a user interface (e.g., user interface 104) may serve as the interactive gateway through which a user initiates and manages a secured session within the system. To begin, the user interacts with the interface by submitting a request to access a secured session, typically through login credentials, such as a username and password, or other authentication mechanisms, such as biometric verification or multi-factor authentication. Upon receiving this first user request, the system processes the authentication by verifying the provided credentials or security tokens against its access control mechanisms.

Once the secured session is authenticated, the system uses the user interface to notify the user of successful access and provide navigation options. Concurrently, the system retrieves the first content source, such as a website or a database, as specified in the session request or default configurations. The user interface then presents the retrieved content or tools for interacting with it, allowing the user to perform tasks like data scraping, content analysis, or integration into other systems. By mediating these actions, the user interface ensures secure and seamless interaction between the user and the system’s core functionalities.

As described herein, a secured session may be a protected communication period between a user and a system, during which data is exchanged under strict security protocols to prevent unauthorized access, tampering, or interception. Its characteristics may include authentication, encryption, session management, and activity monitoring. Authentication ensures that only authorized users can initiate the session, typically through credentials, biometrics, or multi-factor authentication. Encryption secures the data transmitted during the session, making it unreadable to anyone intercepting the communication. Common encryption protocols, such as SSL/TLS, are used to protect sensitive information exchanged over networks.

Session management may involve assigning a unique session identifier to track and maintain the user’s interaction with the system securely. These identifiers, often stored in cookies or session tokens, help ensure continuity and prevent session hijacking. Additionally, secured sessions are characterized by strict timeout rules, which automatically terminate the session after a period of inactivity to reduce vulnerability. Activity monitoring may also be employed to detect and respond to suspicious behaviors during the session. By combining these features, a secured session safeguards the confidentiality, integrity, and availability of the data and system resources involved.

FIG. 1D shows an illustrative user interface (e.g., user interface 110), which displays a dynamic, multi-layer threat taxonomy engine that classifies and normalizes high-risk behavioral indicators (e.g., point-of-contact data) detected during reservation- and payment-level scans. User interface 110 may be displayed upon accessing a secure session. For example, FIG. 1D shows an illustrative user interface, such as user interface 110, that presents a threat taxonomy engine configured to classify indicators detected during reservation and payment scans. The interface is rendered in a browser style window and includes a central table labeled “THREAT TAXONOMY ENGINE” with column headers for risk level, threat vector, identifiers, and status. Each row of the table represents a different threat category with an associated color coded risk level such as Red or Yellow, a three letter threat code such as TER for terrorism, TRF for trafficking, INT for Interpol, ORG for organized crime, ILF for illicit finance, FRD for fraud, CEX for child exploitation, and SYN for synthetic identity. Adjacent cells list example normalized identifiers including truncated device identifiers, phone numbers, email addresses, and masked account numbers, together with descriptive status text such as “Interpol terrorism alert,” “Trafficking activity signal,” “Organized crime network,” “Illicit finance activity,” “Fraud pattern detected,” “No known child exploitation,” and “Clear synthetic identity scan.” The arrangement illustrates how the engine ingests diverse, partially redacted data elements, assigns them to standardized threat codes and color levels, and outputs a clear, reproducible threat posture for each category within a single consolidated view.

In FIG. 1D, the threat taxonomy engine presents the outcome of its analysis in a tabular interface where each row corresponds to a specific threat vector and every risk signal associated with that vector is distilled into a standardized pair consisting of a three letter code and a color state. The three letter code identifies the threat category, such as TER for terrorism, TRF for trafficking, INT for Interpol linked activity, ORG for organized crime, ILF for illicit finance, FRD for fraud, CEX for child exploitation, or SYN for synthetic identity, while the adjacent risk level column displays one of four color labels that indicate severity as Red, Orange, Yellow, or Clear. Intermediate identifiers, such as truncated device IDs, masked payment numbers, or partial contact details, appear in separate cells but do not alter the core representation of risk, which is always summarized through this code and color pairing. Because every row follows the same format regardless of data source or domain, operators viewing the interface can immediately interpret the posture of terrorism risks, financial crime signals, or child exploitation indicators using a single visual and textual language. This consistent encoding allows outputs from different processing routines, external networks, or customer environments to be read and shared across platforms without translation, thereby standardizing how complex, multi domain threats are classified, compared, and communicated in real time.

FIG. 1E illustrates a user interface (e.g., user interface 120), which may show data aggregated from one or more data sources. For example, as shown in user interface 120, the system may aggregate information to generate user profiles based on data scraping, collecting, and/or monitoring. For example, data sources may comprise any origin and/or repository of information that can be accessed, extracted, and used for various purposes such as analysis, reporting, decision-making, or integration into other systems. These sources can take many forms, including structured databases, unstructured text files, web pages, application programming interfaces (APIs), logs, or real-time data streams. They can exist within local systems, cloud environments, or external platforms. Structured data sources, like relational databases, store information in organized tables with predefined schemas, making it easier to query and retrieve specific data. In contrast, unstructured data sources, such as emails, social media content, or multimedia files, require additional processing to extract useful insights. Data sources can also vary by accessibility and ownership, ranging from publicly available resources, such as government open data and publicly indexed web pages, to private and secured sources, such as enterprise databases or proprietary systems. Regardless of their format or location, data sources serve as the foundation for building analytical models, automating processes, and supporting operational or strategic objectives. Access to data sources often requires tools, protocols, or permissions to ensure proper integration and compliance with security and privacy standards.

As described herein, data may be a collection of raw facts, figures, or measurements that represent information about objects, events, or concepts. It serves as the foundational element for analysis, decision-making, and communication. Data can take various forms, including numerical values, textual descriptions, images, audio, or video. It can be structured, organized in a specific format like rows and columns in a database; semi-structured, such as JSON or XML files with tags but no strict schema; or unstructured, such as free-form text, social media posts, or multimedia content. The type of information included in data depends on its source and purpose. For example, transactional data may include timestamps, customer IDs, product details, and payment amounts. Demographic data could contain information such as age, gender, location, and income level. Scientific data might capture temperature readings, chemical compositions, or experimental results. Other examples include metadata, which provides information about other data (e.g., file creation date), and behavioral data, which tracks user interactions, clicks, or activity patterns. Regardless of its type, data is a critical resource for extracting insights, identifying trends, and enabling informed decisions.

Data may be aggregated into user profiles by collecting and combining various pieces of information from multiple sources to create a comprehensive representation of an individual’s behaviors, preferences, and attributes. This process begins with data acquisition, where relevant information, e.g., such as demographic details, transaction history, online activity, social media interactions, and location data, is gathered. These data points are then cleaned, normalized, and structured to ensure consistency and accuracy. The aggregated data may be analyzed to identify patterns and relationships, enabling the creation of a detailed profile. For instance, purchase history and browsing behavior can indicate preferences, while location data might reveal routines or frequently visited places. This information is typically categorized into attributes such as interests, habits, demographics, and predicted needs. Advanced techniques, such as machine learning algorithms, can further enrich profiles by deriving insights like predictive behaviors or segmenting users into groups based on similarities.

User profiles may be used to identify known traffickers and individuals or entities involved in illicit activities by aggregating and analyzing data that reveals patterns, connections, and behaviors indicative of illegal operations. By compiling information from various sources, e.g., such as online activity, financial transactions, social media interactions, communication records, and public databases, profiles can highlight suspicious behavior or unusual patterns that align with known indicators of trafficking or other illicit activities. For instance, frequent transactions across multiple accounts, inconsistent travel patterns, or communications with flagged individuals can signal potential involvement in unlawful activities.

Advanced analytics tools and machine learning algorithms can enhance these profiles by identifying correlations, trends, and anomalies that may not be immediately apparent. For example, network analysis can reveal relationships between entities, exposing hidden connections within trafficking networks. Behavioral profiling can flag activities such as unusual spending, frequent use of anonymizing tools, or participation in dark web marketplaces. Additionally, integrating external intelligence, such as law enforcement data or watchlists, can further refine profiles to match against known offenders or high-risk entities. These user profiles serve as critical tools for law enforcement, financial institutions, and regulatory bodies, enabling targeted investigations and proactive measures to disrupt criminal networks.

As shown in FIG. 1F, user interface 140 may display aggregated data that is organized into a structured form. For example, the system may display aggregated data organized into a structured form that enables users to gain meaningful insights by presenting information in an accessible and interactive format, often through dashboards, tables, or visualizations. For example, when working with financial institutions, the system may ingest raw data from their account and transaction monitoring systems, including transaction details, customer profiles, and flagged activities. The system may then perform advanced data processing to cross-check this information against external data sources, such as business records, email logs, phone directories, or e-transaction handles. By aggregating these datasets, the system creates a detailed and interconnected view of entities involved in financial activities.

By doing so, unlike traditional watchlist systems with high false-positive rates, the system may apply correlation algorithms to identify meaningful patterns and relationships between entities. As one example, the system may link a business address to multiple flagged accounts, cross-reference those accounts with common phone numbers or email addresses, and trace transactions to identify networks of suspicious activity. By drilling down to these details, the system reduces noise and highlights actionable insights, such as connections between individuals or entities that indicate potential human trafficking or money laundering operations.

The system further enhances this analysis by integrating workflows tailored to tracking complex financial crime networks. The system may align these workflows with the workflows financial institutions use to investigate accounts and transactions, creating a seamless process. This integrated approach enables users to visualize and navigate connections between suspicious accounts, trace illicit funds, and uncover links between trafficking operations and money laundering schemes. By marrying these workflows, the system empowers financial institutions to uncover hidden criminal networks, prioritize high-risk cases, and improve the efficiency and effectiveness of their investigative processes.

As shown in FIG. 1G, user interface 160 may display profiles with correlated data and/or risk scores. For example, user interface 160 indicates address, phone numbers, and other information related to a given entity. The system may further generate one or more recommendations that describe probabilities (e.g., “risk scores”) for a given action (e.g., a type of illicit activity).

For example, the system may populate user interface 160 by aggregating and organizing relevant data points, e.g., such as addresses, phone numbers, email addresses, and other identifying information, related to a given entity and displaying them in a structured and interactive format. This process begins with the system querying its data sources, which may include internal records, external databases, and real-time data feeds, to gather all associated information about the target entity. Once collected, the system analyzes and categorizes the data, linking it to related entities or transactions to build a comprehensive profile. The user interface 160 then presents this information in a user-friendly format, such as tables, graphs, or network diagrams, allowing users to easily identify connections, trends, or anomalies within the data.

To provide deeper insights, the system employs advanced analytics to generate recommendations based on probabilities or “risk scores” that evaluate the likelihood of a given action or entity being involved in a specific type of illicit activity. These scores are calculated using machine learning models or rule-based algorithms that analyze patterns in the aggregated data. For instance, the system might assess factors such as transaction frequency, geographic anomalies, or links to high-risk entities and assign a risk score that indicates the probability of involvement in activities like money laundering or human trafficking. The recommendations, accompanied by visual indicators like heatmaps or color-coded alerts, guide users to focus on the most critical areas. By combining comprehensive data visualization with actionable risk assessments, the system enables users to make informed decisions and prioritize their investigative efforts effectively.

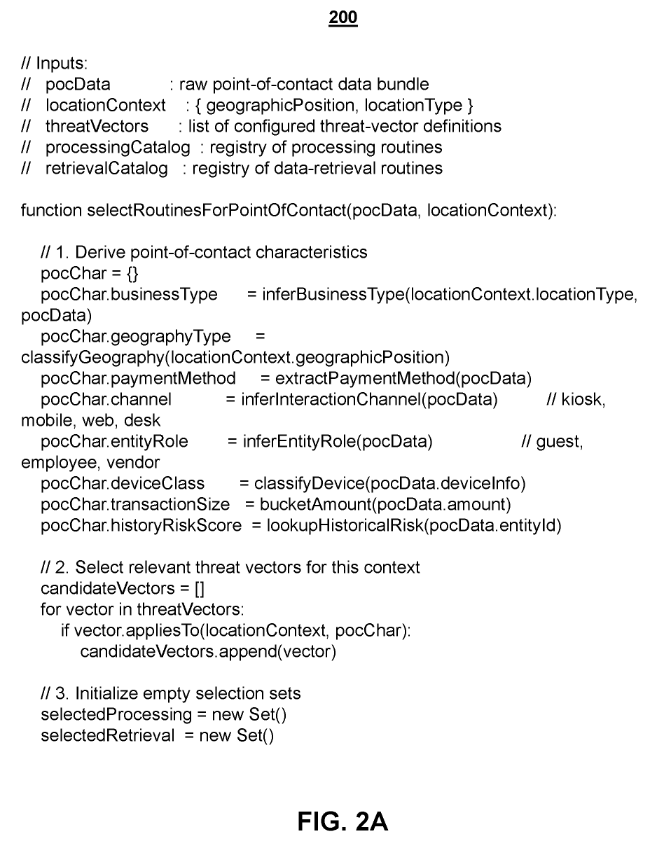

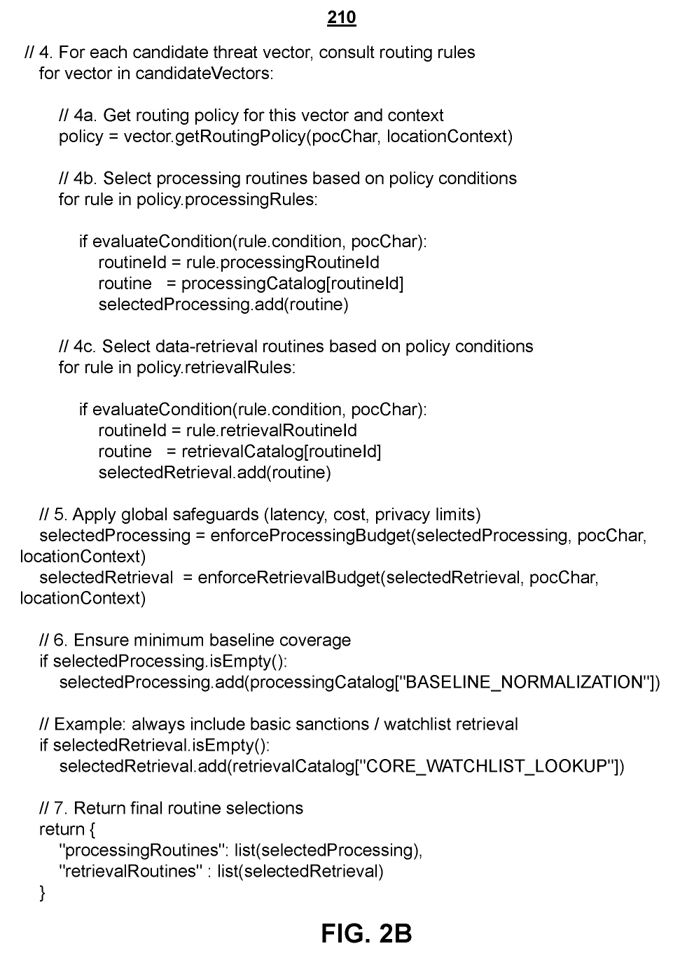

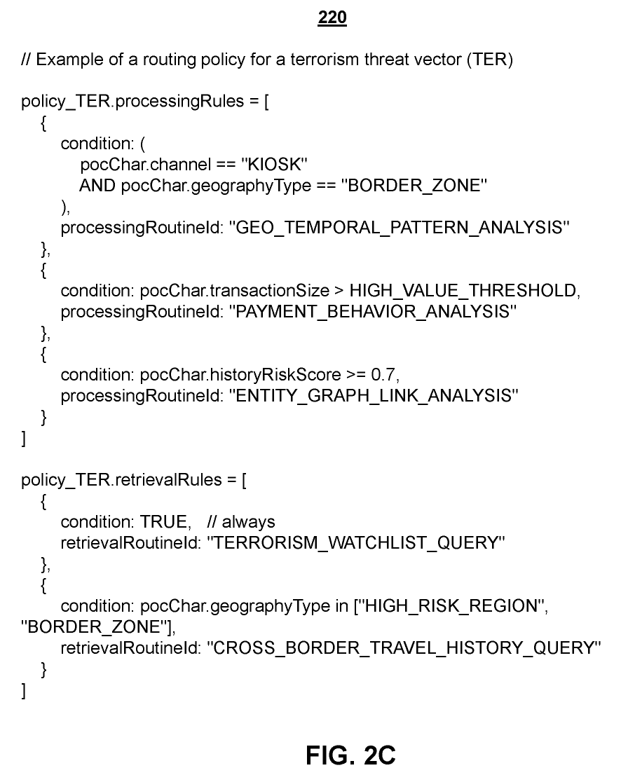

FIGS. 2A-C show illustrative pseudocode for selecting one or more processing and/or data retrieval routines for point-of-contact data, in accordance with one or more embodiments. For example, pseudocode 200 defines a function, selectRoutinesForPointOfContact, that chooses processing and data retrieval routines for a given point of contact. The function receives several inputs, including a raw point of contact data bundle, a location context with geographic position and type, a list of threat vector definitions, and registries of processing and retrieval routines. The first section derives point of contact characteristics. It initializes an object pocChar and infers a business type using the location type and the point of contact data. It classifies geographic type from the geographic position in the location context. It extracts a payment method from the point of contact data and infers an interaction channel such as kiosk, mobile, web, or desk. It also infers an entity role such as guest, employee, or vendor from the point of contact data. Next it classifies the device based on device information contained in the point of contact data, buckets the transaction amount into a transaction size category, and looks up a historical risk score using an entity identifier. The second section selects relevant threat vectors for this particular context. It creates an empty list of candidate vectors and iterates over each configured threat vector. For each vector it evaluates whether the vector applies to the current location context and derived characteristics, and if so, it adds that vector to the candidate list. The third section initializes empty selection sets to hold the results, creating a new set for selected processing routines and another new set for selected retrieval routines.

Pseudocode 200 uses several variables to represent inputs, derived characteristics, and intermediate results. The pocData variable holds the raw point of contact data bundle, such as transaction and device information. The locationContext variable contains contextual data for the interaction, including a geographic position and a location type. The threatVectors variable is a list of configured threat vector definitions that describe different risk or analysis scenarios. The processingCatalog variable is a registry or catalog of available processing routines, while the retrievalCatalog variable is a registry of available data retrieval routines. Within the function, pocChar is an object that aggregates derived point of contact characteristics such as business type, geography type, payment method, interaction channel, entity role, device class, transaction size, and history risk score. The candidateVectors variable is a list used to collect threat vectors that are determined to be applicable to the current context. Finally, selectedProcessing and selectedRetrieval are sets initialized to hold the processing routines and data retrieval routines that will ultimately be chosen based on the applicable threat vectors and derived characteristics.

Pseudocode 200 defines one top level function and invokes several helper functions. The primary function is selectRoutinesForPointOfContact, which takes the point of contact data and location context as parameters and orchestrates the selection of processing and retrieval routines. Within this function, inferBusinessType determines a business type based on the location type and the point of contact data. The classifyGeography function analyzes the geographic position within the location context to assign a geography type. The extractPaymentMethod function parses the point of contact data to identify the payment method that was used. The inferInteractionChannel function evaluates the point of contact data to infer the interaction channel such as kiosk, mobile, web, or desk. The inferEntityRole function uses the point of contact data to classify the role of the entity as, for example, a guest, employee, or vendor. The classifyDevice function processes device information contained in the point of contact data to categorize the device class. The bucketAmount function converts a raw transaction amount into a discrete transaction size bucket. The lookupHistoricalRisk function retrieves or computes a historical risk score based on an entity identifier. Each threat vector object in threatVectors provides an appliesTo method that is called to determine whether that vector is relevant for the current location context and point of contact characteristics.

Pseudocode 210 continues the routine selection process by operating on the candidate threat vectors and constructing the final sets of routines. For each candidate threat vector in the candidateVectors list, the code first obtains a routing policy specific to that vector and the current context by calling getRoutingPolicy with the derived point of contact characteristics and the location context. Using the returned policy, it then iterates through the policy’s processing rules. For each rule it evaluates the rule condition against the point of contact characteristics. When the condition is true, it retrieves the corresponding processing routine from the processingCatalog using the rule’s processing routine identifier and adds that routine to the selectedProcessing set. The code performs an analogous loop for the policy’s retrieval rules, evaluating each rule condition, using any satisfied rule to look up a data retrieval routine in the retrievalCatalog, and adding that routine to the selectedRetrieval set. After rules are applied for all candidate vectors, global safeguards are enforced. This step calls enforceProcessingBudget and enforceRetrievalBudget to adjust the selected processing and retrieval sets so that they conform to constraints such as latency, cost, or privacy limits, taking into account the point of contact characteristics and location context. The pseudocode then verifies that there is at least a minimum baseline of coverage. If no processing routines have been selected, it adds a default baseline normalization routine from the processing catalog. If no retrieval routines have been selected, it adds a core sanctions or watchlist lookup routine from the retrieval catalog as a mandatory example. Finally, the function returns an object that exposes the chosen processing routines and retrieval routines, converting the internal sets into lists.

Pseudocode 210 enables anomaly detection in siloed networks with extreme signal to noise imbalance by routing only the most contextually relevant processing and retrieval routines based on point of contact characteristics. After earlier logic has derived attributes such as business type, geography, entity role, payment method, or interaction channel and has identified applicable threat vectors, each candidate vector in 210 contributes a routing policy that is evaluated against those attributes. Policy rules selectively map the current point of contact to specific normalization, enrichment, feature extraction, and comparison routines drawn from the processing and retrieval catalogs. As a result, the system applies heavier or more specialized analytics only when the point of contact context justifies it, for example when a rule associated with a high risk merchant type or a suspicious geography evaluates as true. Those cases may pull in additional historical lookups, sanctions list retrieval, or high resolution behavioral models, while low risk combinations of attributes satisfy fewer rules and therefore receive lighter weight workflows. Global budget enforcement further suppresses unnecessary processing in high volume environments by constraining the selected routines based on latency, cost, and privacy constraints. Baseline fallbacks ensure that even minimal flows still receive essential normalization and essential watchlist checks. Collectively, this rule driven, context anchored routing suppresses irrelevant computation, focuses analytic capacity on the most informative signals within each silo, and improves the system’s ability to surface subtle anomalies that would otherwise be drowned out by uniformly applied bulk processing.

Pseudocode 210 operates on and updates several variables that were introduced earlier in the routine. The candidateVectors variable contains the list of threat vectors that were previously determined to be applicable to the current point of contact context. For each element of this list the loop variable vector refers to the current threat vector under consideration. Within the loop, policy represents the routing policy returned for that vector when evaluated against the point of contact characteristics and the location context, and this policy provides two collections of rules named policy.processingRules and policy.retrievalRules. During iteration over these collections the loop variable rule denotes the individual routing rule being examined. Each rule contains a condition field that is evaluated against the point of contact characteristics pocChar and it also contains either a processingRoutineId or a retrievalRoutineId that identifies the routine to use when the condition is satisfied. The variables processingCatalog and retrievalCatalog are registries that map those routine identifiers to concrete processing or data retrieval routines. The selectedProcessing and selectedRetrieval variables are sets that accumulate the chosen routines and are progressively updated as rules fire and as global safeguards are applied. The functions enforceProcessingBudget and enforceRetrievalBudget return updated sets that still respect performance, cost, and privacy budgets based in part on pocChar and locationContext, and those returned sets overwrite the previous contents of selectedProcessing and selectedRetrieval. At the end of the pseudocode these two sets are converted into list form and returned as “processingRoutines” and “retrievalRoutines” in the final result object.

Pseudocode 210 invokes several functions to complete the context driven routing of routines. For each candidate threat vector, it calls vector.getRoutingPolicy, which returns a routing policy object tailored to the current point of contact characteristics and the location context. Within that policy, processing and retrieval rules are evaluated by the evaluateCondition function, which takes a rule condition and the point of contact characteristics and returns a Boolean indicating whether the rule applies. When a processing rule condition is satisfied, the code uses the processingCatalog lookup operation to resolve the processingRoutineId to a concrete routine that is then added to the selectedProcessing set. Similarly, when a retrieval rule condition is satisfied, a routine is obtained from the retrievalCatalog using the associated retrievalRoutineId and is added to the selectedRetrieval set. After all candidate vectors have been handled, two safeguard functions, enforceProcessingBudget and enforceRetrievalBudget, are called to adjust the accumulated selections so they respect global limits on latency, cost, and privacy given the current point of contact profile and location context. Finally, conversion functions conceptually represented by list(selectedProcessing) and list(selectedRetrieval) turn the internal sets of routines into ordered lists suitable for inclusion in the returned result structure.

Pseudocode 200 and pseudocode 210 operate as two coordinated stages of a single decision system for routing point of contact data through appropriate processing and retrieval workflows. Pseudocode 200 performs contextualization and candidate selection. It ingests raw point of contact data together with a location context and derives a structured profile of characteristics such as business type, geography, payment method, interaction channel, entity role, device class, transaction size, and historical risk score. Using this profile, it scans a configurable set of threat vectors and collects only those vectors whose applicability criteria match the current context, producing the candidate Vectors list. It also initializes empty sets that will ultimately hold selected processing and retrieval routines. Pseudocode 210 then takes over and, for each candidate threat vector, obtains a routing policy specific to that vector and the current context. It evaluates the policy’s rule conditions against the same point of contact characteristics assembled in pseudocode 200, and for each satisfied rule it looks up the corresponding processing or retrieval routine from the shared catalogs and adds it to the appropriate selection set. After all vectors have contributed their rules, pseudocode 210 enforces global resource and privacy budgets, fills in required baseline routines when needed, and returns the final lists of processing and retrieval routines. Together these two pseudocode segments transform raw, heterogeneous point of contact data into a focused, policy driven set of analytic and data access operations that are tailored to the risk and business context of each individual interaction.

FIG. 2C shows pseudocode 220. Pseudocode 220 illustrates a concrete example of a routing policy for a specific terrorism related threat vector, referred to as TER. It defines two collections of rules, one for processing routines and one for data retrieval routines, that are evaluated against the point of contact characteristics generated earlier in the workflow. The policy_TER.processingRules list contains several entries, each with a condition and an associated processingRoutineId. One rule states that when the interaction channel is a kiosk and the geography type corresponds to a border zone, the system should include a geo temporal pattern analysis routine. Another rule specifies that when the transaction size exceeds a high value threshold, a payment behavior analysis routine should be selected. A third rule triggers an entity graph link analysis routine when the historical risk score for the entity is at or above a specified value. In parallel, the policy_TER.retrievalRules list dictates which external or internal data sources should be queried. One retrieval rule has a condition that is always true, thereby mandating a terrorism watchlist query for every instance governed by this policy. Another retrieval rule becomes active when the geography type falls within a set that includes high risk regions or border zones, in which case the system requests cross border travel history data. When integrated with the selection logic of FIGS. 2A and 2B, this policy object provides detailed, context sensitive instructions that shape both analytics and data enrichment whenever the terrorism threat vector is applicable.

Pseudocode 220 uses point of contact characteristics as explicit conditions that drive which analysis and retrieval actions are taken under the terrorism threat policy. It examines fields within the pocChar structure, such as channel, geographyType, transactionSize, and historyRiskScore, and ties each of these to specific routing decisions. For example, a rule activates geo temporal pattern analysis only when the interaction occurs through a kiosk and in a geography labeled as a border zone, ensuring that this more intensive spatial and temporal analysis is reserved for scenarios that are operationally relevant. Another rule checks whether the transaction size derived for the point of contact exceeds a defined high value threshold, and if so, routes the event to a payment behavior analysis routine, targeting large or unusual payments for deeper scrutiny. A third processing rule reads the historical risk score associated with the entity and enables entity graph link analysis only when that score is elevated, focusing network style analytics on entities already exhibiting risk signals. On the retrieval side, the geography type again serves as a filter, where high risk regions or border zones cause the system to request cross border travel history, while a baseline rule always issues a terrorism watchlist query regardless of other attributes. In this way, the policy converts granular point of contact characteristics into fine grained control over which enrichment and detection routines are applied, tailoring computation to the specific context of each interaction.

Pseudocode 220 can support generation of a final severity characteristic for the terrorism threat vector by treating the selected processing and retrieval routines as factors that modulate risk. Each routine identified by the policy, such as geo temporal pattern analysis, payment behavior analysis, entity graph link analysis, terrorism watchlist query, or cross border travel history query, produces one or more outputs that quantify suspiciousness, anomaly scores, or matches to external intelligence. An earlier stage of the system may assign an initial severity characteristic to the potential terrorism threat vector based on coarse attributes like geography or transaction size. After the routines specified by pseudocode 220 execute, the system can apply weights to their outputs, where the weights themselves are functions of which routines were triggered and how contextually specific they are. For instance, an output from entity graph link analysis might carry a higher weight when it was invoked because the historical risk score exceeded a threshold, while a basic watchlist query result might have a smaller but always present weight. By aggregating these weighted outputs, the system adjusts the initial severity characteristic upward or downward to produce a final severity characteristic that reflects both the strength and relevance of the evidence gathered under the policy. Using this final severity characteristic, the system can generate a dynamic threat identifier for display at a user terminal, such as a composite label that references the terrorism vector and highlights which contextual conditions were met. The interface can present the dynamic threat identifier alongside the numeric or categorical final severity characteristic, allowing an analyst to see in one view that the event is classified under the terrorism policy, that specific kiosk border zone or high value payment rules fired, and that the resulting weighted evidence yields a particular assessed severity.

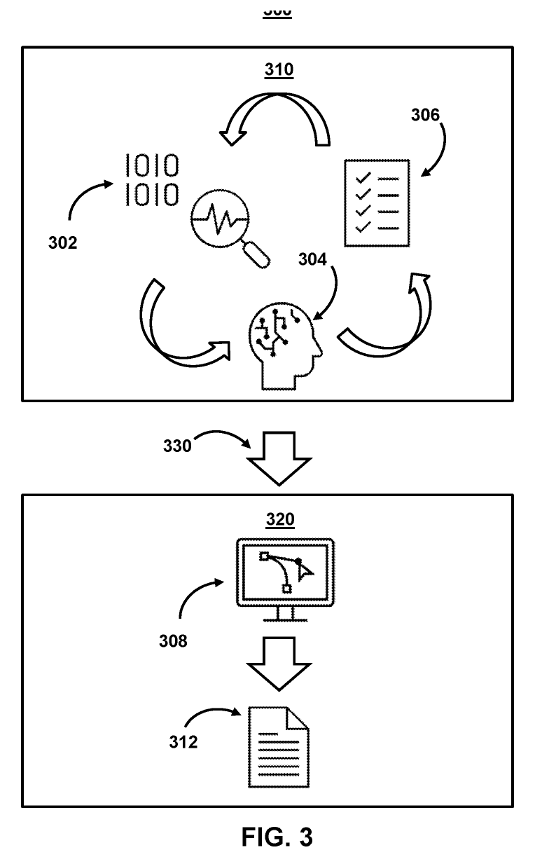

FIG. 3 shows illustrative components for a system used to perform a bifurcated data extraction routine, in accordance with one or more embodiments. For example, system 300 shows data source 302, which may be parsed and analyzed by tool 304. For example, using a first routine of a bifurcated data extraction routine, tool 304 may compare data elements (or indicia of the data elements) in data source 302 to data elements (or indicia thereof) corresponding to a plurality of encryption and/or obfuscation types (e.g., known data elements 306) to identify an encryption and/or obfuscation type in data source 302. System 300 may perform multiple iterations to find content nested within multiple encryption and/or obfuscation types.

As shown in FIG. 3, system 300 may include device 310. Device 310 (as well as the other devices and components described herein) may comprise electronic storage. Electronic storage devices are systems designed to electronically store information in various formats and media. These devices may utilize non-transitory storage and/or computer-readable media to retain data and can include both system storage, which is integrally provided within servers or client devices (e.g., substantially non-removable storage), and removable storage that can be connected to servers or client devices through interfaces such as USB ports, FireWire ports, or disk drives. Electronic storage media encompass a wide range of technologies, including optically readable storage media like optical disks, magnetically readable storage media such as magnetic tapes, hard drives, and floppy disks, as well as electrical charge-based storage media like EEPROM and RAM. Solid-state storage media, such as flash drives, are another common type of electronic storage. Additionally, virtual storage resources, including cloud storage, virtual private networks (VPNs), and other virtualized systems, are considered part of electronic storage. These devices are capable of storing various forms of data, including software algorithms, information processed or determined by processors, data obtained from servers or client devices, and other essential information that supports the functionality of various processes.

For example, system 300 may perform a bifurcated data extraction routine to efficiently retrieve and process content from data source 302, even when the data is encrypted or obfuscated. In this routine, data source 302 is first retrieved by the system and then parsed and analyzed by tool 304. The bifurcated process begins with a first routine, where tool 304 compares the data elements, e.g., or their indicia, present in data source 302 with a repository of known data elements or patterns (e.g., known data elements 306) corresponding to various encryption and obfuscation types. Through this comparison, tool 304 identifies the specific encryption and/or obfuscation type applied to the content in data source 302. This identification process may require multiple iterations, particularly when the content is nested within multiple layers of encryption or obfuscation, with each iteration peeling back a layer to reveal the next.

In some embodiments, system 300 and/or one or more components herein may be implemented using an application-specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that the design of the circuit is customized for a given application. In some embodiments, system 300 may use an integrated circuit system where one or more integrated circuits are spread throughout a system, network, and/or one or more devices. In such a case, the system design may ensure that the circuits are integrated with other electronic components like connectors, power supplies, and sensors to form a complete and functional electronic system. This integration allows for the implementation of sophisticated tasks in devices needed for one or more specified applications.

System 300 may send and/or receive data to device 320, which may generate output 330. System 300 may facilitate the transfer of data between device 310 and device 320, enabling the generation of output 330. Device 310, which functions as a storage device, holds the data that is sent to device 320, such as a CPU. A CPU, or Central Processing Unit, is the primary component of a computer responsible for executing instructions and performing computations necessary for various processes and functions. The CPU may interpret and execute instructions from programs and operating systems through a cycle of fetching, decoding, and executing commands. This cycle begins with the CPU retrieving an instruction from the system’s memory, followed by decoding it to understand the required operation and finally executing it by performing arithmetic, logical, control, or input/output tasks. The CPU relies on its internal components, including the arithmetic logic unit (ALU) for mathematical operations, the control unit (CU) for directing data flow, and registers for temporary data storage. By leveraging its clock speed and multiple cores in modern processors, the CPU can execute complex processes efficiently, enabling the functionality of applications and systems.

Device 320 processes the received data by implementing one or more applications and/or models to perform specific tasks or computations. These applications or models analyze, transform, or process the input data to produce the desired output 330. This output may represent the results of calculations, simulations, or other operations conducted by the applications or models on device 320. The system ensures seamless communication between the devices, allowing for efficient data transfer and output generation.

Output 330 may represent the result of processing data or executing instructions. In the case of a CPU, outputs can include processed data, computational results, or responses to input commands. For models, outputs often consist of predictions, classifications, decisions, or other data derived from the model’s algorithms or trained parameters. Once generated, the output is typically stored in a suitable storage medium, such as system memory (RAM), a local storage device (e.g., hard drive or SSD), or a networked storage system. This stored output can then be used in various ways depending on the application. For example, it might be displayed to users as visual or textual information, serve as input for subsequent computational tasks, or be transmitted to other devices or systems for further processing. The efficient storage and utilization of outputs are essential for enabling real-time responsiveness, supporting iterative processes, and ensuring seamless integration with larger workflows or systems.

From this, tool 304 may apply a second routine, of the bifurcated data extraction routine, to extract data from data source 302 using an extraction function from a plurality of extraction functions, based on the detected data encryption and/or obfuscation type. The system may then generate for display, on a user interface, the non-encrypted and/or non-obfuscated content that is extracted.

For example, once the encryption and/or obfuscation type is detected, tool 304 proceeds to the second routine of the bifurcated data extraction process. In this step, it applies a targeted extraction function, selected from a library of extraction functions, that is specifically designed to decode or decrypt the identified type. For example, if the data is encoded in base64, the corresponding function will decode it; if it is encrypted using AES, the appropriate decryption algorithm will be applied, provided the key is available. Similarly, for obfuscated data, tool 304 might reverse engineered transformations or execute associated scripts to reconstruct the original content.

After successfully extracting the non-encrypted and/or non-obfuscated content, the system organizes and prepares it for visualization. It then generates a display on a user interface (e.g., user interface 308), presenting the clean and readable content (e.g., content 312) to the user in an accessible format. This bifurcated approach allows system 300 to handle complex, layered encryption and obfuscation scenarios with precision and adaptability, ensuring that the extracted data is both accurate and actionable for downstream applications.

In some embodiments, system 300 may use an I/O (Input/Output) path between devices, which may refer to the communication pathway that facilitates the exchange of data between computing devices or systems. An I/O path may encompass a variety of communication networks such as the Internet, mobile phone networks, mobile voice or data networks like 5G or LTE, cable networks, public switched telephone networks (PSTN), or combinations of these. These networks provide the infrastructure for transmitting data across different mediums. The I/O path can also include specific communication paths, such as satellite links, fiber-optic connections, cable connections, Internet-based communication paths (e.g., IPTV), and free-space links that support wireless or broadcast signals. In addition to external communication networks, computing devices may feature internal communication paths that integrate hardware, software, and firmware components. For example, multiple computing devices can operate as part of a unified cloud-based platform, leveraging interconnected communication paths to function collectively. These I/O paths are essential for ensuring seamless data flow, supporting applications, and enabling distributed computing environments.

In some embodiments, system 300 may be a cloud system. A system structured as a cloud system is designed to provide scalable, on-demand access to computing resources and services over the Internet or other networks. In a cloud system, multiple interconnected servers, data centers, and storage devices work together to deliver virtualized computing power, storage, and applications. These resources are hosted remotely in distributed locations, creating a virtualized environment that can dynamically allocate resources based on user demands. The cloud system is typically organized into three main service models: Infrastructure as a Service (IaaS), which offers virtualized hardware and network resources; Platform as a Service (PaaS), which provides tools and frameworks for application development; and Software as a Service (SaaS), which delivers software applications to users. The system relies on communication paths, including high-speed fiber-optic networks, satellite links, and wireless connections, to enable seamless interaction between users and the cloud infrastructure. Advanced management tools and load-balancing mechanisms ensure reliability, efficiency, and fault tolerance within the system. This structure allows users to access computing resources flexibly and cost-effectively without the need to maintain physical hardware.

In some embodiments, system 300 may use one or more APIs. An API, or Application Programming Interface, is a set of rules and protocols that allows different components within a system, such as system 300, to communicate and interact seamlessly. APIs define how software applications, services, or devices can request and exchange data, enabling interoperability between components regardless of their underlying technologies. Within a system, an API acts as a bridge between different modules, such as databases, user interfaces, or external services, facilitating the flow of information and the execution of commands.

For instance, in system 300, an API might enable device 310, a data storage component, to provide information to device 320, a processing unit. Device 320 could use the API to request specific data, execute operations, or send processed results back to another component. The API specifies the format and structure of the requests and responses, such as using JSON or XML, and enforces security protocols like authentication tokens or encryption to ensure secure communication.

APIs can also enable external systems to interact with system 300. For example, a financial application could use an API to query account balances, initiate transactions, or retrieve fraud detection reports generated by a model housed within the system. By standardizing interactions, APIs simplify the integration of diverse components, improve scalability, and support modular system designs, making it easier to expand or update individual parts without disrupting the entire system.

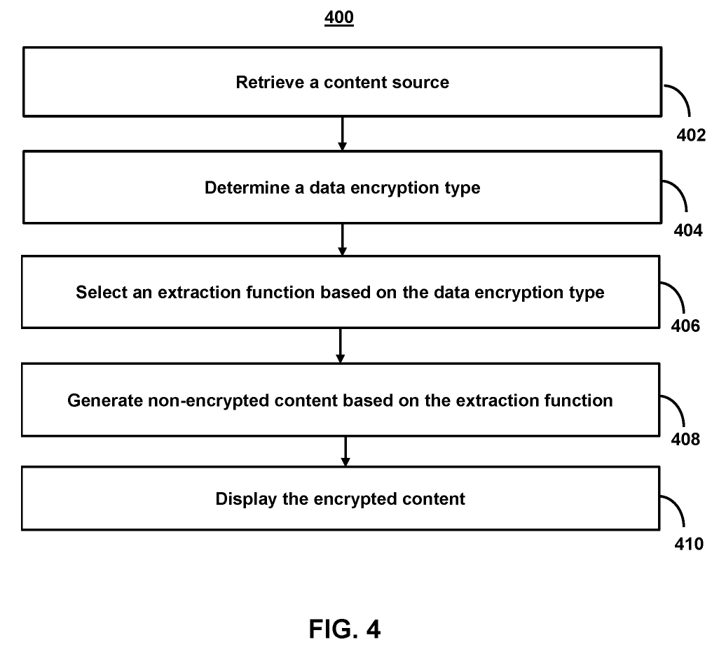

FIG. 4 shows illustrative steps for data collection from encrypted content sources comprising multi-layered encryptions and nested content, in accordance with one or more embodiments. For example, the system may use process 400 (e.g., as implemented on one or more system components described above) for data scraping encrypted content sources comprising multi-layered encryptions and nested content using bifurcated data extraction routines that include initial analysis and tagging routines prior to dynamically selected extraction routines.

At step 402, process 400 (e.g., using one or more components described above) retrieves a content source. For example, the system may retrieve a first content source, wherein the first content source comprises a plurality of encrypted content masked by one or more of a plurality of data encryption types. The process may begin with the system issuing a request to the content source’s endpoint, which may be a website, API, or database. This request is performed using network protocols such as HTTP/HTTPS or database query languages like SQL, depending on the source type.

In some embodiments, the system may retrieve the first content source by initiating a secured session for extracting data from the first content source and recording a first state for the first content source corresponding to the secured session, wherein the first non-encrypted content is archived based on the first state. For example, the system may provide authentication credentials or tokens, ensuring only authorized access to the content source. The secured session is then initiated, and the system records the first state of the content source, which represents its initial structure, data, and metadata at the time of access. Once the secured session is active, the system parses and analyzes the content source to identify and isolate the encrypted and non-encrypted data elements. For encrypted elements, the system applies decryption or decoding methods as needed to retrieve readable content. Simultaneously, the first state of the content source, including the structure, timestamps, and any associated metadata, is archived for reference. This archiving process ensures that the system maintains a snapshot of the content source at the moment of data extraction, which can be used for validation, audit, or historical analysis. The system then extracts the first non-encrypted content based on the first state and organizes it into a structured format suitable for further processing or analysis. By associating the extracted content with the archived first state, the system provides a clear and traceable record of the data in its original context. This method not only ensures secure and accurate data retrieval but also enhances transparency and accountability in handling sensitive or protected information.

In some embodiments, the system may retrieve the first content source by receiving a first user request to begin a secured session and authenticating the secured session based on the first user request. For example, the request may include authentication details such as a username and password, biometric data, or multi-factor authentication tokens. The system validates these credentials against its authentication mechanisms, which may involve checking them against a database, verifying cryptographic tokens, or communicating with an external identity provider.

At step 404, process 400 (e.g., using one or more components described above) determines a data encryption and/or obfuscation type. For example, the system may execute a first routine, of a bifurcated data extraction routine, on the first content source to determine a first data encryption type for first encrypted content in the first content source. During this routine, the system compares the data elements in the content source with a repository of known encryption and/or obfuscation patterns and methods. For instance, the system may recognize base64-encoded strings by their unique syntax (e.g., padding with =), or detect hash values based on their length and character distribution, such as SHA-256 hashes. It may also analyze the source code or scripts embedded in the content source to identify encryption-related functions or algorithms, such as JavaScript code used for client-side encryption or obfuscation. The system may use tools like regular expressions, heuristic analysis, and runtime monitoring to detect transformations applied to the data. For dynamically generated content, the system may execute JavaScript or other embedded scripts within a controlled environment, such as a headless browser, to observe how encrypted data is produced or transformed. Through this analysis, the system identifies the encryption and/or obfuscation type associated with the first encrypted content. By completing the first routine, the system determines the specific data encryption and/or obfuscation type, which is then used to inform the second routine. This step ensures that the appropriate decryption or decoding method can be applied to extract the original content, enabling accurate and efficient data retrieval while maintaining the integrity of the extraction process.

In some embodiments, the system may execute the first routine on the first content source to determine the first data encryption type for the first encrypted content in the first content source by determining a plurality of content subsets at the first content source, iteratively parsing code on each of the plurality of content subsets to extract first encrypted content from the first content source, and determining dependencies between each of the plurality of content subsets based on the first encrypted content. For example, the system executes the first routine on the first content source to determine the first data encryption type for the first encrypted content by systematically analyzing the content through a process of identifying, parsing, and mapping relationships among its subsets. The process begins with the system segmenting the first content source into a plurality of content subsets. These subsets may represent distinct sections of the source, such as individual HTML elements, scripts, or data payloads embedded within the content source. This segmentation is based on structural markers like tags, attributes, or delimiters that define logical boundaries within the source. The system then iteratively parses the code associated with each content subset to isolate and extract encrypted content. During this parsing, it identifies data elements exhibiting characteristics of encryption, such as irregular alphanumeric patterns, fixed-length strings, or encoded formats like base64 or hexadecimal. The system uses tools such as regular expressions, pattern recognition algorithms, and runtime script execution to extract and analyze these data elements. For instance, if a subset contains JavaScript code that generates encrypted content dynamically, the system executes the code in a controlled environment, such as a headless browser, to observe and capture the resulting encrypted output. As each subset is parsed, the system examines the relationships and dependencies between the subsets to understand how the encrypted content is generated or processed. For example, one subset may define a script that applies encryption, while another subset contains the data inputs or keys required for the encryption process. By analyzing these dependencies, the system identifies how the subsets interact to produce or modify the encrypted content. This iterative approach enables the system to pinpoint the specific encryption type used for the first encrypted content. The system cross-references the patterns and transformations observed during parsing with a library of known encryption types, ultimately determining the encryption method. This information is critical for guiding subsequent steps in the bifurcated data extraction routine, where the system applies the appropriate decryption or decoding method to retrieve the original, non-encrypted content. By mapping dependencies and iteratively analyzing subsets, the system ensures a thorough and accurate determination of the encryption type, even for complex or nested content sources.

In some embodiments, the system may execute the first routine on the first content source to determine the first data encryption type for the first encrypted content in the first content source by identifying a plurality of data elements in the first content source, determining one or more data encryption type indicia that correspond to one or more of the plurality of data elements, and comparing the one or more data encryption type indicia to a plurality of data encryption types to determine that the one or more data encryption type indicia correspond to the first data encryption type. For example, the process may begin with the system parsing the first content source to isolate a plurality of data elements. These elements may include strings, script outputs, attributes, or other discrete units of data embedded within the content source. Each data element is extracted and examined for characteristics that suggest the application of an encryption method. Next, the system evaluates these data elements to identify one or more encryption type indicia, e.g., distinctive patterns, formats, or behaviors that indicate a specific encryption technique. For instance, the system might detect base64 encoding through the presence of a specific character set and padding (=), or identify hashed data by analyzing the fixed length and hexadecimal structure typical of hash algorithms like SHA-256. Similarly, encrypted text generated by algorithms like AES or RSA may exhibit randomized, unreadable patterns with no discernible semantic meaning. Once the encryption type indicia are identified, the system compares these indicators to a library of known data encryption types. This library may include predefined patterns, transformation rules, or metadata associated with common encryption methods. The comparison process involves matching the observed indicia against these references to determine which encryption type corresponds to the identified patterns. For example, if the indicia include a specific data format and the presence of an initialization vector in a script, the system might conclude that the encryption type is AES-CBC (Cipher Block Chaining). By completing this process, the system determines that the one or more data encryption type indicia correspond to the first data encryption type. This identification allows the system to prepare for the next step in the bifurcated data extraction routine, where it applies the appropriate decryption or decoding function to extract the non-encrypted content. This method ensures precise identification of encryption types, enabling the system to handle diverse and complex encryption scenarios effectively.

In some embodiments, the system may execute the first routine on the first content source to determine the first data encryption type for the first encrypted content in the first content source by determining a first location of the first data encryption type and determining a first encryption mapping of the first content source based on determining that the first location corresponds to the first data encryption type. For example, the process may begin with the system analyzing the structure and components of the first content source, such as scripts, metadata, and embedded data elements. During this analysis, the system identifies the first location associated with the encryption type, which could include specific sections of code, script files, or data attributes where encryption operations are defined or applied. To pinpoint the first location, the system searches for markers or patterns indicative of encryption. These may include function names (e.g., “encrypt,” “encode”), variable names linked to encryption keys or algorithms, or the presence of cryptographic libraries (e.g., AES, RSA, or Base64 encoders). For instance, JavaScript code may include functions that process data through encryption logic, or API responses may include metadata specifying the encryption scheme used. The system may execute or simulate the source’s runtime behavior in a controlled environment to trace the flow of data and observe where and how encryption is applied. Once the first location is determined, the system constructs a first encryption mapping of the content source. This mapping outlines how the encryption type is implemented and applied across the source, including which data elements are encrypted, the encryption parameters (e.g., keys, initialization vectors), and the relationships between encrypted and unencrypted data. The mapping also establishes the scope and dependencies of the encryption type within the content source, highlighting connections between different parts of the source where encryption operations occur. By determining that the first location corresponds to the first data encryption type and creating the encryption mapping, the system gains a comprehensive understanding of how the encryption type operates within the content source. This mapping is essential for guiding subsequent steps in the data extraction process, enabling the system to accurately apply the appropriate decryption or decoding functions to retrieve the original, non-encrypted content. The method ensures precision and efficiency in handling encrypted content, even in complex or layered scenarios.

In some embodiments, the system may execute the first routine on the first content source to determine the first data encryption type for the first encrypted content in the first content source by determining a series of operations to perform on a plurality of text strings of the nested attribute and extracting a first text string of the plurality of text strings based on the series of operations. For example, the process may begin with the system parsing the content source to locate encrypted or obfuscated data within attributes, such as those found in HTML tags, JSON objects, or API responses. These attributes may contain nested structures where multiple layers of transformations or encodings are applied to the data. To process these nested attributes, the system identifies a series of operations that have been performed on the plurality of text strings contained within the attributes. This involves examining the structure and content of the attributes for patterns or scripts that indicate how the text strings have been transformed. For example, the system may detect base64 encoding, string reversals, or obfuscation through interleaved characters. Additionally, it may analyze associated scripts or functions in the source code to trace how data is manipulated before being displayed or transmitted. The system determines the sequence of operations by either static code analysis (reviewing the source code for transformation functions) or dynamic execution (observing how the text strings are processed at runtime). For example, if a JavaScript function decrypts a string after reversing it, the system records the sequence as “reverse -> decrypt.” Once the series of operations is identified, the system applies them in reverse order to extract a first text string from the plurality of text strings in the nested attribute. By sequentially undoing each transformation, the system reconstructs the original, non-encrypted, or non-obfuscated text string. This extracted text string is then analyzed further to confirm the encryption type, such as by comparing its characteristics to known encryption patterns or verifying its integrity against expected results. Through this method, the system accurately determines the first data encryption type applied to the first encrypted content, enabling it to proceed with the next steps of data extraction and decryption. This approach is particularly effective for handling complex, nested attributes where multiple transformations obscure the underlying data.

In some embodiments, the first data encryption type may comprise an image, and wherein applying the first extraction function to the first encrypted by determining text data in the image and extracting the text data from the image. For example, the system processes a first data encryption type that comprises an image by using optical character recognition (OCR) or similar text extraction techniques to identify and retrieve text data embedded within the image. This method is necessary when encrypted data or obfuscated information is represented visually rather than in standard text or encoded formats, making it inaccessible to traditional text-based parsing and decryption tools. The process may begin with the system identifying the image containing the encrypted data. This identification may involve analyzing the content source for image files linked to relevant data, such as images embedded in HTML, delivered via API responses, or stored as attachments. Once the image is retrieved, the system applies an extraction function specifically designed for image processing. The extraction function uses OCR technology to analyze the visual elements of the image and detect text characters. This involves breaking the image into pixel-level data, identifying regions of interest where text might be located, and interpreting the shapes and patterns of the characters. The OCR process can handle various text styles, fonts, and sizes and may include preprocessing steps like noise reduction, contrast adjustment, and image scaling to improve accuracy. Once the text data is identified, the system extracts it into a machine-readable format, such as a plain text string. If the extracted text data is itself encrypted or obfuscated, the system then applies additional processing routines, such as decoding or decrypting the text using the appropriate algorithms, based on the identified encryption type. For example, the extracted text might include a base64-encoded string or a hashed value, which the system can process further to retrieve the original content. By determining text data in the image and extracting it, the system effectively bridges the gap between visual data representation and text-based decryption processes. This approach ensures that encrypted or obfuscated data embedded in images can be accessed, analyzed, and integrated into the broader data extraction workflow, enabling a comprehensive analysis of complex content sources.

In some embodiments, the first data encryption type comprises a style element of the first encrypted content, and wherein applying the first extraction function to the first encrypted content comprises determining metadata corresponding to the style element, formatting the metadata into a data variable, and extracting the data variable. For example, the system may process a first data encryption type that comprises a style element of the first encrypted content by analyzing the metadata associated with the style element, transforming it into a structured format, and extracting meaningful data from it. This method is particularly useful when encrypted or obfuscated data is embedded within styling information, such as CSS (Cascading Style Sheets) attributes, inline styles, or dynamically applied styles. The process may begin with the system identifying the style element associated with the encrypted content. This may involve parsing the content source to locate relevant <style> tags, inline style attributes in HTML elements, or linked external CSS files. The system analyzes these style elements to identify metadata that may hold obfuscated data, such as custom font mappings, color codes, positioning attributes, or encoded data embedded within style rules. Next, the system retrieves the metadata corresponding to the style element and formats it into a structured data variable. For example, if the style element uses a custom font to display obfuscated characters, the system analyzes the font’s metadata to map each glyph back to its corresponding character. Similarly, if the style contains encoded values (e.g., color codes or numerical offsets), the system applies transformations to decode or interpret these values as structured data. Once the metadata is formatted into a usable data variable, the system extracts the variable for further processing. This may involve applying additional decoding or decryption steps if the extracted data variable is still encrypted or obfuscated. For instance, if the style metadata encodes text using a transformation function, the system reverses the transformation to retrieve the original content. By processing the style element in this manner, the system effectively uncovers encrypted or obfuscated data hidden within visual or design-oriented components of the content source. This approach ensures that all potential data storage mechanisms, including unconventional ones like style metadata, are thoroughly analyzed and incorporated into the overall data extraction workflow, enabling comprehensive and accurate retrieval of the first encrypted content.

At step 406, process 400 (e.g., using one or more components described above) selects an extraction function based on the data encryption type. For example, the system may execute a second routine, of the bifurcated data extraction routine, to select a first extraction function from a plurality of extraction functions based on the first data encryption type. The process may begin with the completion of the first routine, where the system determines the encryption type applied to the encrypted content. The identified encryption type is then used as a key criterion to match the appropriate extraction function from the system’s library of functions. The system may maintain a repository of extraction functions, each designed to handle specific encryption or obfuscation methods. These functions include algorithms for decryption (e.g., AES, RSA), decoding (e.g., base64, URL encoding), and other transformation reversals (e.g., reversing strings, removing interleaved characters). Each function is associated with metadata that describes the encryption type it can process, input parameters it requires, and any dependencies or prerequisites for execution. Using the first data encryption type as a reference, the system queries the repository to identify the extraction function that corresponds to the encryption method. For example, if the first data encryption type is determined to be base64 encoding, the system selects the base64 decoding function. If it is AES encryption, the system selects the AES decryption function and ensures that the necessary decryption key and initialization vector (IV) are available. Once the appropriate extraction function is selected, the system configures it with the required parameters, such as the encrypted content, keys, or additional contextual information obtained during the first routine. The configured function is then executed to extract the original, non-encrypted content from the first encrypted content. This methodical selection process ensures that the system applies the correct and most effective function to handle the identified encryption type, enabling accurate and efficient data extraction. By maintaining a robust library of extraction functions and aligning their application with the specific encryption type, the system effectively processes diverse and complex encrypted content sources.

At step 408, process 400 (e.g., using one or more components described above) generates non-encrypted content based on the extraction function. For example, the system may generate the first non-encrypted content based on applying the first extraction function to the first encrypted content. The system may generate the first non-encrypted and/or non-obfuscated content by applying the first extraction function to the encrypted and/or obfuscated content, effectively reversing the transformations that conceal the original data. The process begins with the system retrieving the encrypted or obfuscated content, which may have been identified and isolated during earlier routines. The system then applies the selected extraction function, configured to handle the specific encryption or obfuscation type identified. For encrypted content, the extraction function uses the appropriate decryption algorithm and necessary keys to decode the data. For instance, if the content is encrypted using AES, the function applies the AES decryption algorithm along with the decryption key and initialization vector (IV) to recover the original plaintext. If the encryption involves asymmetric methods, such as RSA, the function uses the corresponding private key for decryption. For obfuscated content, the extraction function reverses the obfuscation process. This could involve decoding base64-encoded strings, reversing scrambled characters, removing interleaved dummy data, or executing JavaScript functions that dynamically generate the original content. In cases where multiple layers of obfuscation are applied, the function iteratively processes each layer until the underlying content is fully revealed. Once the extraction function completes its operation, the system validates the output to ensure that the generated content matches the expected format or integrity of the original data. This may involve checksum verification, pattern matching, or semantic checks to confirm the content’s authenticity and accuracy. The resulting non-encrypted and/or non-obfuscated content is then structured and formatted for further use, such as displaying it on a user interface, integrating it into a database, or using it for analytical purposes. By effectively applying the extraction function to reverse encryption and/or obfuscation, the system transforms inaccessible or concealed data into readable and actionable information, supporting the broader objectives of data aggregation, analysis, or monitoring.

In some embodiments, the system may generate the first non-encrypted and/or non-obfuscated content based on applying the first extraction function to the first encrypted content by receiving a first data output from the first extraction function and formatting the first data output into a tabular representation to generate the first non-encrypted content. After the first extraction function processes the encrypted and/or obfuscated content, it produces a first data output, which typically consists of the raw, decrypted, or de-obfuscated information. This output may initially be unstructured or semi-structured, depending on the encryption or obfuscation method used and the nature of the content. To transform this raw data into the first non-encrypted and/or non-obfuscated content, the system processes the data output to organize it into a tabular format. This involves parsing the output to extract relevant fields or attributes and mapping them to predefined columns in the table. For instance, if the decrypted data includes information about transactions, the system might extract fields such as “Transaction ID,” “Date,” “Amount,” and “Recipient” and assign them to corresponding columns. Similarly, if the data pertains to user profiles, attributes like “Name,” “Email,” “Phone Number,” and “Address” might populate the table. The system ensures that the tabular representation maintains consistency, readability, and usability. It may apply additional formatting, such as standardizing date formats, aligning numerical values, or categorizing data into groups for easier interpretation. Validation checks are performed during this step to ensure the extracted data aligns with expected formats or schema requirements. Once the tabular representation is generated, it becomes the final form of the first non-encrypted content. This structured format is highly useful for visualization, reporting, or integration into databases or analytical tools. By formatting the extracted data into a table, the system provides a clear and accessible view of the decrypted content, facilitating seamless downstream processing and decision-making.

In some embodiments, the system may generate the first non-encrypted content based on applying the first extraction function to the first encrypted content by receiving a first data output from the first extraction function, wherein the first data output comprises an address and formatting the first data output, using an address cleansing algorithm, to populate a standardized address field with the address. For example, the system may generate first non-encrypted and/or non-obfuscated content by applying a first extraction function to the encrypted and/or obfuscated content, receiving the resulting data output, and using an address cleansing algorithm to standardize and format the extracted address. After the first extraction function processes the encrypted or obfuscated content, it produces a first data output, which may include raw or partially structured data such as an address. This address may not initially conform to standard formats due to inconsistencies, variations, or incomplete components in the original data. To ensure the address is usable and accurate, the system applies an address cleansing algorithm. This algorithm processes the extracted address by verifying its components, correcting errors, and structuring it into a standardized format. For example, the algorithm may normalize street abbreviations (“St.” to “Street”), correct misspellings, complete missing components (e.g., city, state, or ZIP code) using context or reference databases, and remove extraneous characters. The algorithm may also validate the address against official postal or geographical databases to ensure its accuracy and completeness. Once cleansed and validated, the system formats the address to populate a standardized address field. This involves mapping the address components, e.g., such as street name, building number, city, state, and ZIP code, into designated fields within a structured schema. The standardized address field ensures consistency, making it easier to use the data for downstream processes like matching, analysis, or integration into other systems. This approach enables the system to transform raw, extracted address data into a reliable and uniform format, facilitating accurate reporting, analysis, and operational use. By combining data extraction with address cleansing, the system ensures the first non-encrypted and/or non-obfuscated content is both precise and ready for practical application.

In some embodiments, the system may generate the first non-encrypted content based on applying the first extraction function to the first encrypted content by receiving a first data output from the first extraction function, wherein the first data output comprises pixel width metadata, and determining a numeric score based on the pixel width metadata. For example, the system may generate the first non-encrypted and/or non-obfuscated content by applying the first extraction function to the encrypted content, receiving the resulting data output, and analyzing specific metadata, such as pixel width metadata, to derive a numeric score. After the system applies the first extraction function to the encrypted content, it produces a first data output that includes pixel width metadata. This metadata typically pertains to visual or graphical elements, such as text rendered with custom fonts, images, or user interface components, and provides details about the pixel width of these elements. The system processes the pixel width metadata to interpret its significance and extract meaningful information. For instance, pixel width may correspond to the dimensions of rendered text characters, which could be encoded in the visual presentation as part of an obfuscation scheme. The system uses the pixel width values to calculate a numeric score, applying a predefined algorithm or heuristic that translates the metadata into a quantitative representation. This algorithm might involve summing pixel widths, applying weights to specific ranges, or analyzing patterns in the metadata to detect encoded information. The resulting numeric score is then used to populate a structured field in the first non-encrypted and/or non-obfuscated content. For example, the score might represent the importance, frequency, or categorization of the associated data. This approach is particularly useful in scenarios where obfuscation techniques leverage visual properties, such as custom font mappings or spacing-based encoding. By analyzing pixel width metadata and deriving a numeric score, the system converts visual or metadata-based information into actionable, non-obfuscated content. This enables downstream applications, such as content analysis, categorization, or pattern recognition, to utilize the derived information effectively.

In some embodiments, the system may generate the first non-encrypted content based on applying the first extraction function to the first encrypted content by receiving a first data output from the first extraction function, wherein the first data output comprises a first date format, and reformatting the first data output to a second date format. For example, the system may generate the first non-encrypted and/or non-obfuscated content by applying the first extraction function to the first encrypted content, receiving the resulting data output, and reformatting the extracted data into a standardized format. When the first extraction function processes the encrypted content, it produces a first data output that may include a date in a specific format, such as “MM/DD/YYYY” or “YYYY-MM-DD.” However, to ensure consistency and compatibility across systems, the system reformats this date into a second date format, such as “DD-MM-YYYY” or another format required by downstream applications. The reformatting process may begin with the system parsing the extracted date to identify its components, including the day, month, and year. The system then uses predefined rules or date transformation algorithms to rearrange these components into the desired format. For example, if the original date is in the “MM/DD/YYYY” format, and the target format is “YYYY-MM-DD,” the system extracts the month, day, and year values and reorders them accordingly, ensuring the separators are adjusted to match the second format. During this process, the system may also validate the date to ensure its accuracy and handle edge cases, such as invalid dates or ambiguous formats. For instance, it might cross-check the extracted date against a calendar to confirm its validity or account for locale-specific differences in date representations. Once the date is reformatted into the second format, it is integrated into the structured, non-encrypted, and non-obfuscated content, ready for use in reporting, analysis, or storage. This reformatting ensures that the extracted data adheres to consistent standards, enhancing its usability and interoperability across various systems and workflows.

In some embodiments, the system may generate the first non-encrypted content based on applying the first extraction function to the first encrypted content by receiving a first data output from the first extraction function, wherein the first data output comprises a longitude or a latitude, and determining a geospatial coordinate based on the longitude or the latitude. For example, the system may generate the first non-encrypted and/or non-obfuscated content by applying the first extraction function to the first encrypted content, extracting geospatial data such as a longitude or latitude, and combining or validating this data to determine a geospatial coordinate. When the first extraction function processes the encrypted content, it outputs a first data set that includes either longitude, latitude, or both. These values may initially be in an isolated or partial form, requiring further processing to create a complete and usable geospatial coordinate. The system begins by parsing the extracted longitude and latitude values, ensuring they are valid numerical representations within their respective ranges. Longitude values are checked to fall between -180° and +180°, while latitude values must fall between -90° and +90°. If only one value is present (e.g., longitude), the system may reference additional data sources or contextual metadata to retrieve the missing counterpart, ensuring the complete coordinate is formed. Once both longitude and latitude values are available and validated, the system combines them into a geospatial coordinate, typically represented in formats such as decimal degrees (e.g., 37.7749, -122.4194). The system may also enrich the coordinate by associating it with additional geospatial metadata, such as a place name, address, or region, using reverse geocoding APIs or databases. This step adds contextual information that enhances the usability of the geospatial coordinate. The final geospatial coordinate is then structured into the non-encrypted and non-obfuscated content, ready for visualization, mapping, or integration into location-based systems. By processing longitude and latitude values into a standardized and actionable geospatial coordinate, the system ensures the extracted data is accurate, meaningful, and applicable for downstream applications like geospatial analysis or navigation.

At step 410, process 400 (e.g., using one or more components described above) displays the encrypted content. For example, the system may generate for display, on a user interface, the first non-encrypted content. The system may generate the first non-encrypted content for display on a user interface by transforming the extracted data into a visually organized, interactive, and user-friendly format. After the content is decrypted or de-obfuscated using the first extraction function, the system processes and structures the resulting data into a form suitable for presentation. This preparation involves formatting, organizing, and enriching the data to ensure it is both readable and actionable. The system begins by categorizing the extracted content based on its type, such as text, numerical data, images, or geospatial coordinates. Each data type is formatted appropriately: text may be styled with headings or labels, numerical data may be formatted with appropriate units or precision, and geospatial data may be plotted on a map. The system may also apply additional processing, such as summarizing large datasets into tables or charts or grouping related data into logical sections. Once formatted, the data is integrated into the user interface. The system generates user interface components such as tables, charts, lists, or maps to present the content in an intuitive manner. Interactive elements, such as filters, drop-down menus, or clickable items, may be included to allow users to explore and manipulate the data directly. For example, if the content includes transaction data, the system might display it in a sortable table with columns for transaction ID, amount, and date. The system also ensures that the user interface is responsive and adaptable to different devices and screen sizes, providing a seamless experience for users accessing the content on desktops, tablets, or mobile devices. Accessibility features, such as screen reader support or high-contrast modes, may be incorporated to enhance usability for all users. Finally, the system populates the user interface with the processed data and renders it for display, enabling users to view, analyze, and act on the first non-encrypted content in real time. By leveraging thoughtful design and robust data processing, the system ensures that the extracted content is presented clearly and effectively to support user workflows and decision-making.

In some embodiments, the system may generate for display the first non-encrypted content by parsing the first non-encrypted content for a plurality of data elements that correspond to encrypted content and determining whether to process the first non-encrypted content with the bifurcated data extraction routine based on the plurality of data elements. For example, the system may generate for display the first non-encrypted content by parsing it to identify a plurality of data elements that correspond to potentially encrypted or obfuscated content, and then determining whether additional processing with the bifurcated data extraction routine is required. Once the first non-encrypted content is extracted using the initial decryption or de-obfuscation process, the system analyzes this content to ensure that all relevant information has been fully resolved and is ready for display. The system begins by parsing the first non-encrypted content to identify data elements that may still indicate traces of encryption or obfuscation. These elements could include patterns such as partially decoded strings, nested encoded data, or anomalies like inconsistent formats or unreadable characters. During this step, the system applies pattern recognition techniques, regular expressions, or heuristics to detect such elements and flag them for further analysis. If the system identifies a plurality of data elements corresponding to encrypted or obfuscated content, it evaluates whether the remaining content requires additional processing using the bifurcated data extraction routine. This determination is based on criteria such as the presence of known encryption or obfuscation indicators, dependencies on nested content, or incomplete data fields that suggest further decryption or decoding is needed. If additional processing is necessary, the system dynamically reapplies the bifurcated data extraction routine to the flagged data elements. The first routine identifies the encryption or obfuscation type applied to the remaining content, while the second routine applies the appropriate extraction function to resolve it fully. Once this iterative process is complete, the updated non-encrypted content is validated to ensure completeness and accuracy. Finally, the system formats the fully resolved content into a structured and visually coherent representation for display on the user interface. By dynamically assessing and reprocessing the first non-encrypted content, the system ensures that all data elements are accurately extracted and presented, enabling users to interact with clear and actionable information.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

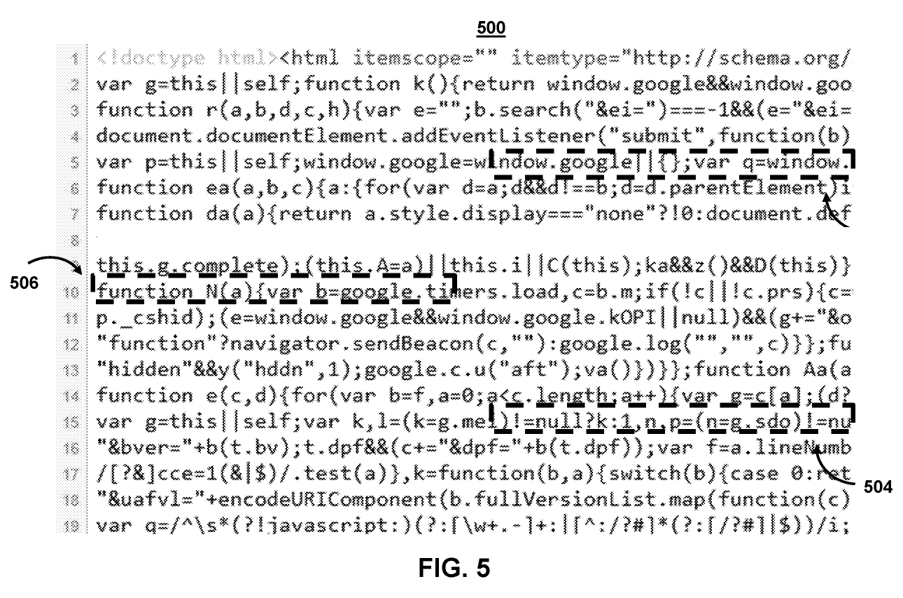

FIG. 5 shows an illustrative diagram showing the parsing of data elements, in accordance with one or more embodiments. For example, FIG. 5 shows data source 500. Data source 500 may comprise illustrative source code representing a web page. Data source 500 may comprise a plurality of data elements that may be parse. For example, a webpage may be represented as a structured collection of elements defined by source code, primarily written in markup languages like HTML (HyperText Markup Language) and enhanced by technologies such as CSS (Cascading Style Sheets) and JavaScript. The source code serves as the blueprint that browsers use to render and display the webpage to users. HTML forms the backbone of the webpage, organizing content into elements such as headings, paragraphs, links, images, and tables. Each HTML element may be defined by tags, which outline the structure and semantics of the content. CSS may be used alongside HTML to style the webpage, controlling the appearance of elements by defining properties like colors, fonts, spacing, and layout. This separation of content (HTML) and presentation (CSS) ensures flexibility and consistency in design. JavaScript, a scripting language, adds interactivity and dynamic behavior to webpages. It enables features like form validation, animations, data fetching, and real-time updates without requiring the user to reload the page.

When a user accesses a webpage, the browser retrieves the source code and associated files from a server. It then processes the HTML, applies the CSS styles, and executes any JavaScript scripts to construct and display the final webpage. The representation of the webpage in the browser is known as the Document Object Model (DOM), which allows for real-time interaction and manipulation by JavaScript or browser extensions. This layered and modular approach makes webpages both functional and visually appealing.

In the source code of a webpage, images, interactive content, and textual content are represented using specific HTML elements, attributes, and scripts that define their structure and behavior. Textual content is the simplest to represent, typically enclosed within HTML tags like <p> for paragraphs, <h1> to <h6> for headings, <span> for inline text, and <a> for hyperlinks. These tags allow the browser to render text appropriately and make it readable to users.

Images are represented using the <img> tag, which includes attributes like src to specify the image file’s location (e.g., a URL or file path) and alt to provide alternative text for accessibility or when the image cannot be displayed. Additional attributes, such as width and height, control the image’s dimensions.

Interactive content is often implemented using a combination of HTML, CSS, and JavaScript. For example, buttons and form elements are represented by tags like <button>, <input>, and <form>, with attributes to define their types and functions. JavaScript can then be used to handle events such as clicks, form submissions, or hover effects, enabling interactivity. Complex interactive elements, such as video players or embedded maps, are typically represented using specialized tags like <video> or <iframe>. The <canvas> or <svg> tags can also be used for creating dynamic graphical content, often in conjunction with JavaScript.

By combining these elements, the source code defines the content, attributes, and/or scripts used to present textual content, images, and/or interactive components and defines how they appear and behave. For example, content may be embedded or nested within other content in the source code by organizing elements hierarchically using HTML tags. This nesting structure allows developers to group and arrange content logically and visually. For instance, a <div> (division) tag is commonly used as a container to group related elements, such as text, images, or other containers, creating sections within a webpage. Elements placed inside a <div> are considered “nested” within it.

Text and other content can also be nested within structural or semantic tags. For example, a paragraph <p> might include inline elements like <strong> or <em> to emphasize specific text or <a> tags to create hyperlinks. Similarly, a <ul> (unordered list) or <ol> (ordered list) tag contains multiple <li> (list item) tags, nesting individual list items within the broader list structure. More complex nesting may occur with multimedia and interactive elements. For example, a <figure> tag might contain an <img> tag for an image and a <figcaption> tag for its caption, combining both elements into a single cohesive unit. Interactive components often involve deeply nested structures, such as a <form> element containing various <input> fields, <label> tags, and <button> elements to handle user input. Embedding external content, such as videos or maps, also involves nesting. An <iframe> tag, for instance, can embed another webpage or content source within the current page while maintaining its own nested structure.

The system may parse the source code to identify data elements by analyzing the HTML, CSS, and JavaScript using a structured approach, typically employing a parsing engine or library to interpret the code. The process may begin by fetching the source code of a webpage, either through direct access to the file or via HTTP requests. The system then breaks down the code into its constituent parts, including tags, attributes, and text, and organizes it into a hierarchical representation known as the Document Object Model (DOM). Within the DOM, each HTML element is treated as a node, and its relationships to other nodes, e.g., such as parent, child, or sibling elements, are preserved. The system navigates this tree structure to locate specific data elements based on criteria such as tag names, attributes, classes, IDs, or other identifiable patterns. For example, if the goal is to extract all product names from a webpage, the system might search for nodes with specific tags like <h2> or <div> combined with class attributes like product-title. Advanced systems use techniques such as CSS selectors, XPath queries, or regular expressions to pinpoint and extract desired data elements efficiently. For dynamically generated content, the system may also execute JavaScript code embedded in the source, using tools like headless browsers to render the page fully before parsing. Once the relevant data elements are identified, they are extracted and stored in a structured format, such as JSON or a database, for further processing or analysis.

This parsing process enables the system to systematically identify, tag, and/or retrieve data elements (e.g., element 502, element 504, and/or element 506) from complex and dynamically changing webpages, making it a critical step in web scraping, data aggregation, and content analysis. The system may then determine a plurality of data elements in the content source corresponding to a first data encryption and/or obfuscation type, of the plurality of data encryption and/or obfuscation types, wherein the plurality of data elements comprises one or more indicia of the first data encryption and/or obfuscation type.

A system determines a plurality of data elements in a content source corresponding to a first data encryption and/or obfuscation type by analyzing the structure, patterns, and transformations applied to the data in the source. The process begins with parsing the content source to identify potential data elements and examining their representations in the source code. The system searches for specific indicators, or “indicia,” of encryption or obfuscation methods, such as unusual encoding patterns, JavaScript functions applied to data elements, or the presence of encrypted strings or hashes.

To detect these indicia, the system may analyze attributes like unusual character sequences, base64-encoded strings, or patterns consistent with hash functions such as SHA-256. It may also monitor the execution of scripts that dynamically transform or encode data at runtime, using tools like headless browsers or JavaScript debuggers to trace these operations. By identifying the transformations applied, the system determines the encryption or obfuscation type and associates it with the corresponding data elements in the content source.

As described herein, a data encryption and/or obfuscation type may comprise a mechanism to prevent data scraping and/or disguise or protect data from automated extraction. Examples of these types may include encryption (e.g., converting data into a ciphered format using algorithms like AES (Advanced Encryption Standard) or RSA, requiring a key to decrypt it back to a readable state), obfuscation (e.g., applying transformations that make the data difficult to interpret, such as encoding it in base64, reversing the string, or injecting meaningless characters or elements to confuse parsers), dynamic generation (e.g., using JavaScript to render data only in the browser, requiring the system to execute the page’s code to access the obfuscated content), font-based obfuscation (e.g., replacing text with custom fonts where visible characters are mapped to unrelated glyphs, making the text unreadable when extracted directly), and/or image-based obfuscation (e.g., displaying critical data as images rather than text, preventing direct text extraction).

By determining the encryption and/or obfuscation type and analyzing how it is applied, the system can implement countermeasures, such as decryption algorithms or script execution, to extract and interpret the protected data. For example, the system may determine the encryption or obfuscation type by analyzing the patterns, structures, and transformations applied to data within the content source. This process involves examining the source code, scripts, and data payloads for clues that indicate specific encryption or obfuscation methods. For example, the system may detect base64-encoded strings by identifying patterns like “==“ at the end of strings, or it might recognize hashes by their fixed-length hexadecimal or alphanumeric patterns, such as those produced by SHA-256. Similarly, the system may identify obfuscation techniques like reversed strings, interleaved dummy characters, or data dynamically generated through JavaScript.

To understand how these techniques are applied, the system may simulate or monitor the content’s runtime behavior. This can involve executing JavaScript within a controlled environment, such as a headless browser, to observe how encrypted or obfuscated data is decoded or manipulated before being displayed to the user. The system may trace script execution paths, inspect function calls, and capture intermediate data states to map the transformation process.

Once the encryption or obfuscation type and its application method are determined, the system implements countermeasures to extract and interpret the protected data. For encryption, the system may use predefined decryption algorithms if the keys or methods are known. For example, if data is encrypted with AES and the key is available, the system applies the AES decryption algorithm to recover the original content. For obfuscated data, the system may reverse the transformation process, such as decoding base64 strings, removing interleaved dummy characters, or executing the same JavaScript functions to restore readable data.

If the system encounters dynamically generated content, it may use script execution tools to simulate the browser’s behavior, rendering the content as it would appear to a user. During this process, the system captures and extracts the de-obfuscated data at runtime. These techniques, combined with robust parsing and decoding logic, allow the system to bypass various encryption and obfuscation measures, ensuring that the protected data can be accessed and analyzed for legitimate purposes, such as regulatory compliance, fraud detection, or content aggregation.

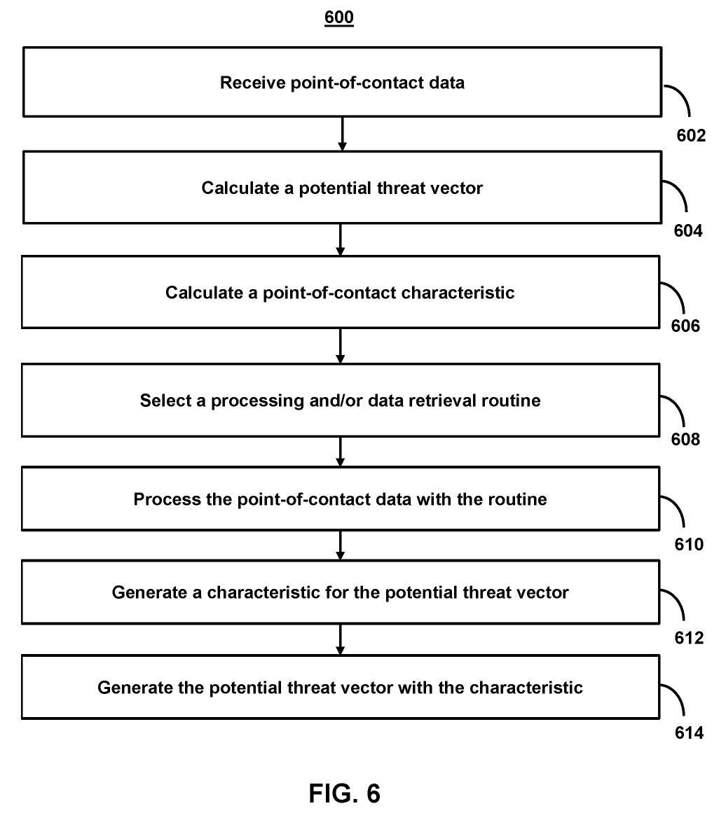

FIG. 6 shows illustrative steps for detecting anomalies in siloed networks, in accordance with one or more embodiments. For example, the system may use process 600 (e.g., as implemented on one or more system components described above) for detecting anomalies in siloed networks featuring extreme signal-to-noise imbalances using point-of-contact based filtering criteria for data processing and data retrieval. For example, the system detects anomalies in siloed networks with extreme signal to noise imbalance by using point of contact characteristics as the primary filter for both computation and data access. At ingestion, each interaction is profiled by attributes such as business type, geography, entity role, payment method, and channel, and these attributes determine which normalization routines, feature extraction steps, and comparison baselines are invoked. Only workflows that are relevant to that specific profile are executed, so high risk contexts, such as cash intensive merchants or border zone kiosks, receive enriched processing, tighter thresholds, and specialized pattern matching, while low risk contexts are routed through lighter pipelines. In parallel, the same point of contact characteristics govern which external or cross network datasets are queried, allowing the system to pull only those siloed references that are informative for the current interaction, such as regional mobility baselines, industry specific fraud norms, trafficking corridor maps, compromised identity repositories, or dark web intelligence feeds. This dual filtering of processing and retrieval suppresses irrelevant analysis, concentrates resources on the most promising signals inside each silo, and enables cross referencing that would not happen with uniform, source agnostic queries. For threat vectors such as terrorism financing, human trafficking, organized crime, or synthetic identity abuse, the system uses the contextual cues at the moment of contact to decide how aggressively to analyze data and which networks to consult, thereby amplifying faint, domain specific irregularities that would otherwise be hidden in massive volumes of benign activity. To make these heterogeneous, context dependent anomaly signals actionable in real time, the system maintains a dynamic threat identifier for each potential threat vector. The identifier starts from a baseline tied to the initial point of contact profile and is updated as specialized routines run and as targeted datasets are retrieved, with each anomaly contributing a weighted adjustment that reflects both its magnitude and the significance of the analytic path that uncovered it. By the time the interaction reaches a decision point, the threat identifier encapsulates a normalized severity measure and a compact explanation grounded in the underlying context, allowing operators to see a clear, unified indication of risk rather than a cloud of raw scores from disparate silos.

At step 602, process 600 (e.g., using one or more components described above) receives point-of-contact data. For example, the system may receive point-of-contact data at a first location. The system may receive point of contact data at a first location by monitoring interactions that occur through one or more ingress channels associated with that location. For example, when a customer initiates a transaction at a physical terminal, kiosk, mobile device, or web interface linked to a particular branch, store, or facility, the front-end application collects raw interaction details such as timestamps, device identifiers, transaction amounts, payment instruments, geospatial coordinates, and basic entity identifiers. These details are packaged into a point of contact data bundle and transmitted over a secure communication link to the system’s intake service that is logically or physically situated at the first location. The intake service validates message integrity, performs basic schema checks, and attaches location context metadata that identifies the site, region, and channel through which the interaction occurred. Once this enriched bundle is accepted, it becomes the point of contact record that drives subsequent characterization, policy evaluation, and anomaly detection for that specific first location.

In some embodiments, the system may receive point-of-contact data at a first location by receiving a user input into a user terminal at the first location and calculating the point-of-contact data based on the user input. The system may receive point of contact data at a first location by capturing user input entered into a user terminal positioned at that location and transforming this input into a structured interaction record. When a user engages with the terminal, for example by submitting a transaction form, authenticating, or requesting a service, the terminal software records the values supplied through on screen fields, keypads, card readers, scanners, or biometric sensors. These raw inputs can include identifiers, payment details, requested operation types, and supplemental information such as declared travel plans or purpose of use. The terminal also contributes contextual attributes like the terminal identifier, its configured business role, and a timestamp. The system then calculates point of contact data by combining the captured inputs with the contextual attributes and applying local transformations such as validation, normalization of formats, geolocation lookup from terminal identifiers, and derivation of transaction metrics like amount buckets or preliminary risk hints. The resulting point of contact data bundle, which encodes both what the user entered and the circumstances of entry at the first location, is then forwarded to downstream components for characterization, policy evaluation, and anomaly detection.

At step 604, process 600 (e.g., using one or more components described above) calculates a potential threat vector. For example, the system may calculate a potential threat vector based on the first location, wherein the potential threat vector has a first characteristic. The system may calculate a potential threat vector based on the first location by interpreting the contextual attributes associated with that location and mapping them to one or more predefined threat categories. After receiving the point of contact data and the accompanying location metadata, the system consults configuration tables or learned models that link specific location features to relevant threat patterns. These features can include geographic region, border proximity, local crime or conflict indicators, the type of facility operating at the first location, and historical incident statistics observed there. Using these inputs, the system computes which threat vector, such as terrorism financing, human trafficking, organized crime logistics, or regional fraud typologies, is most likely to be pertinent. The identified vector is instantiated as a potential threat vector object that carries a first characteristic, for example an initial severity or baseline risk level that reflects how risky interactions at that location are considered in general. This first characteristic may be derived from prior alerts, regulatory designations, or aggregated anomaly scores for the site and serves as the starting point that will later be refined as additional, interaction specific processing and data retrieval are performed.

In some embodiments, the system may calculate the potential threat vector based on the first location by calculating a location identifier corresponding to the first location and comparing the location identifier to a plurality of potential threat vector. The system may calculate the potential threat vector based on the first location by first deriving a location identifier that uniquely represents that site in the detection framework. When point of contact data is received, the system uses attributes such as GPS coordinates, terminal or branch codes, network addresses, or administrative region tags to compute or look up a normalized location identifier. This identifier is then used as a key to query a repository of predefined potential threat vectors, each of which is associated with one or more location identifiers or with patterns that can be matched to them, such as membership in a border zone group, a high-risk urban district, or a category of facilities. The system compares the calculated location identifier against this plurality of threat vector entries and identifies which vectors list that identifier explicitly or satisfy their location matching rules. The matching vector, or set of vectors, is instantiated as the potential threat vector for the interaction, and the system copies from the matched definition an initial characteristic such as default severity, baseline risk tags, or applicable regulatory constraints that will guide subsequent analysis.

In some embodiments, the system may determine the first characteristic by calculating threat vector category for the potential threat vector and calculating the first characteristic based on the threat vector category. The system may determine the first characteristic by first assigning the potential threat vector to a specific threat vector category and then deriving the characteristic from that category’s predefined properties. After a potential threat vector has been identified for an interaction, the system analyzes its defining attributes, such as associated location identifiers, typical modus operandi, targeted assets, and historical impact, and uses these to classify the vector into a category like terrorism financing, human trafficking, cyber enabled fraud, or organized crime logistics. Each category in the configuration repository carries canonical parameters, including default severity ranges, priority levels, regulatory importance, and recommended response urgency. Once the category for the potential threat vector is known, the system calculates the first characteristic by applying the category parameters, for example by assigning a base severity score, a qualitative risk tier, or an initial confidence level that reflects how threats in that category should be weighted relative to others. This characteristic then serves as the starting risk assessment that will be updated as interaction specific analytics and external data retrieval refine the evaluation.

In some embodiments, the system may determine the first characteristic by comparing the potential threat vector to a predetermined set of identifiers, wherein each of the predetermined set of identifiers corresponds to a respective potential threat vector and calculating an identifier corresponding to the potential threat vector based on comparing the potential threat vector to the predetermined set of identifiers, wherein the identifier comprises an alpha-numeric code. The system may determine the first characteristic by assigning an alpha numeric identifier to the potential threat vector through comparison against a predetermined set of identifiers. After the potential threat vector has been derived from the first location and associated context, the system evaluates its defining attributes, such as location class, involved entities, and suspected activity type, and compares these attributes to a catalog in which each entry represents a reference potential threat vector and is labeled with a unique alpha numeric code. Matching can involve exact equality on key fields, rule based similarity, or scoring functions that measure closeness between the observed vector and each catalog entry. When the best matching entry is found, the system selects its alpha numeric code as the identifier corresponding to the current potential threat vector. This identifier implicitly carries a mapped severity or priority level defined in the catalog, so the act of assigning the code also establishes the first characteristic for the potential threat vector. The system can then use this coded characteristic as a compact, machine readable representation of baseline risk for subsequent processing and for communication to downstream components.

In some embodiments, the system may determine the first characteristic by calculating a graphical characteristic (e.g., a color signature) corresponding to the identifier and using the graphical characteristic to determine the first characteristic (e.g., how to display the potential threat vector). The system may determine the first characteristic by translating the alpha numeric identifier of the potential threat vector into a graphical characteristic and then using that graphical representation to define how the threat should be displayed. After an identifier is assigned, the system consults a mapping table or visualization model that associates each identifier or identifier family with a specific graphical characteristic, such as a color signature, icon shape, or intensity pattern. For example, identifiers linked to high urgency vectors might map to saturated red tones, medium level vectors to amber, and low-level vectors to muted green or blue. The system calculates the graphical characteristic for the current identifier and stores it as part of the threat vector’s metadata. This graphical characteristic then becomes the first characteristic for display purposes, guiding how the potential threat vector appears in user interfaces, dashboards, or alert queues. When rendering the interaction at a terminal or analyst console, the system applies the calculated color signature or related visual styling to highlight the vector’s presence and baseline severity, ensuring that users can recognize its importance at a glance without parsing the underlying identifier or numeric codes.

In some embodiments, the system may determine the first characteristic by normalizing the point-of-contact data based on the first location to generate normalized point-of-contact data and calculating an identifier corresponding to the normalized point-of-contact data. The system may determine the first characteristic by first normalizing the point of contact data with respect to the first location and then deriving an identifier from the normalized representation. After raw point of contact data is captured at the first location, the system applies location aware normalization routines that reconcile local formats, units, and conventions into a unified schema. These routines can adjust currency amounts into a common base, translate local time stamps into a standard time zone, map location specific product or service codes into global categories, and reconcile regional identity formats into canonical identifiers. The result is normalized point of contact data that is comparable across locations while still preserving location specific context. The system then feeds this normalized data into a classification or encoding component that compares the normalized attributes to reference patterns or uses a model to assign an alpha numeric identifier representing the potential threat vector most consistent with the observed interaction. That identifier, derived from data that has been normalized for the first location, becomes the first characteristic associated with the potential threat vector and provides a stable basis for subsequent risk scoring and display.

In some embodiments, the system may determine the first characteristic by comparing the point-of-contact data to a coded taxonomy and determining the first characteristic based on comparing the point-of-contact data to the coded taxonomy. The system may determine the first characteristic by evaluating the point of contact data against a coded taxonomy that organizes threat patterns into structured categories and codes. After the data is collected, the system parses its elements such as transaction type, amount, counterparties, device attributes, and location context, and aligns these elements with the dimensions defined in the taxonomy, for example sector, modus operandi, channel, and geography. Each branch of the taxonomy is annotated with codes that represent specific threat scenarios or baseline risk levels. The system compares the observed attributes to these coded definitions using rule based logic or scoring algorithms to find the best matching code or combination of codes. Once the most appropriate taxonomy entry is identified, the associated code and its predefined properties, such as default severity, regulatory relevance, and monitoring priority, are used to set the first characteristic for the potential threat vector. In this way, the first characteristic directly reflects where the point of contact data resides within a standardized, organization wide taxonomy of threats, enabling consistent interpretation and downstream handling.

In some embodiments, the system may determine the first characteristic by processing the point-of-contact data for personally identifiable information and masking the personally identifiable information in the point-of-contact data. The system may determine the first characteristic by first processing the point of contact data to detect personally identifiable information and then masking that information before further analysis. When the data is ingested, a privacy protection module scans fields such as names, account numbers, addresses, government identifiers, email addresses, and device fingerprints using pattern matching and entity recognition techniques. Any values classified as personally identifiable information are transformed through masking operations, for example replacing characters with placeholders, hashing identifiers, or tokenizing them so that they remain linkable for risk analysis but are no longer human readable. The resulting privacy preserved dataset is then used to infer the first characteristic of the potential threat vector, such as a baseline severity score or risk label, ensuring that the determination relies on behavioral and contextual patterns rather than on exposed raw identity attributes. By tying the first characteristic to masked data, the system maintains compliance with privacy requirements while still computing a meaningful initial assessment that can guide subsequent threat vector processing and display.

In some embodiments, the system may determine the first characteristic by selecting the potential threat vector from a plurality of potential threat vectors for the first location, calculating a first geographic position and first location type corresponding to the first location, and calculating an initial severity characteristic based on the first geographic position and the first location type. The system may determine the first characteristic by first choosing an appropriate potential threat vector for the first location and then deriving an initial severity level from the geographic attributes of that location. When point of contact data arrives, the system identifies all potential threat vectors that are configured as applicable to the first location and selects one or more candidates based on matching criteria such as facility function or historical incident patterns. In parallel, it calculates a first geographic position for the location, for example by resolving terminal coordinates, address data, or network information, and determines a first location type such as border crossing, transportation hub, retail outlet, financial branch, or online access node anchored in that geography. Using these two attributes, the system consults configuration rules or statistical models that map combinations of geographic position and location type to baseline risk levels. A border zone transportation hub might receive a higher default severity than an urban retail outlet, while a remote kiosk in a low-risk region might receive a lower baseline. The resulting initial severity characteristic, derived from the first geographic position and location type associated with the selected potential threat vector, is stored as the first characteristic that frames subsequent analysis of that interaction.

At step 606, process 600 (e.g., using one or more components described above) calculates a point-of-contact characteristic. For example, the system may calculate a point-of-contact characteristic in the point-of-contact data. The system may calculate a point of contact characteristic in the point of contact data by transforming raw interaction fields into a structured, semantically meaningful attribute. After receiving the raw data bundle from the user terminal or channel, the system parses elements such as timestamp, transaction type, device metadata, payment instrument, user role, and location context. It then applies a characteristic specific inference routine that combines selected fields according to predefined logic or learned models. For example, to calculate an interaction channel characteristic, the system might examine device type, network path, and terminal identifiers to classify the contact as kiosk, mobile, web, or in person desk. To derive a business type characteristic, it can map merchant codes or organizational identifiers to standardized industry categories. Similar routines can compute geography type from coordinates, entity role from authentication context, or transaction size from monetary fields by bucketing amounts. The resulting value is written back into the point of contact record as a point of contact characteristic, providing a normalized, high-level description that later stages use for policy selection, anomaly detection, and severity estimation.

In some embodiments, the system may calculate the point-of-contact characteristic in the point-of-contact data by parsing the point-of-contact data for a user input and modifying the user input based on the first location to calculate the point-of-contact characteristic. The system may calculate the point of contact characteristic by examining user input contained in the point of contact data and adjusting that input according to properties of the first location. After the user interacts with a terminal at the first location, the raw data bundle includes explicit entries such as selected transaction type, declared purpose, entered merchant category, or chosen service options. The system parses the bundle to extract these user supplied fields and then consults configuration tables or models that define how such inputs should be interpreted for that specific location. For example, a service code entered at a border kiosk might map to a different risk relevant category than the same code at a downtown branch, and a self-declared role such as visitor or contractor may carry different meanings depending on the site’s security posture. The system modifies or re labels the user input using these location aware mappings, normalizing it into a standardized value that captures both what the user entered and how that input should be understood in the context of the first location. This normalized, location adjusted value is stored as the point of contact characteristic and becomes a key feature used in downstream policy selection and anomaly detection.

At step 608, process 600 (e.g., using one or more components described above) selects a processing and/or data retrieval routine. For example, the system may process the point-of-contact data using the first processing routine or the first data retrieval routine. For example, the system may, based on the point-of-contact characteristic, select a first processing routine, from a plurality of processing routines, or a first data retrieval routine, from a plurality of data retrieval routines, for the point-of-contact data. The system may process the point of contact data by using the calculated point of contact characteristic to choose an appropriate processing routine or data retrieval routine and then executing that routine on the data. After the characteristic is derived, the system consults a routing policy that links ranges or combinations of characteristics to specific members of a catalog of processing routines and a catalog of retrieval routines. For a given interaction, the policy evaluation might determine that a high-risk channel and geography combination requires an advanced anomaly detection algorithm, while a low-risk combination only needs baseline normalization. When the policy selects a first processing routine, the system passes the point of contact data through that routine, which can perform tasks such as cleansing, feature extraction, behavioral scoring, or pattern matching. Alternatively, or in addition, the policy can select a first data retrieval routine that issues targeted queries into internal repositories or external networks, for example retrieving cross border travel history, sanctions list results, or prior transaction summaries linked to the entities in the point of contact record. The outputs of the executed processing and retrieval routines are then attached back to the record, providing enriched information that drives subsequent threat vector assessment and severity calculation.

In some embodiments, the system may select the first processing routine from the plurality of processing routines by calculating a feature-extraction process corresponding to the potential threat vector and implementing the feature-extraction process in the first processing routine. The system may select the first processing routine from the plurality of processing routines by first determining which feature extraction process is most relevant to the potential threat vector and then choosing a routine that implements that process. After a potential threat vector is identified, the system analyzes its category, associated behaviors, and required evidence types, and consults a configuration that maps each threat vector to one or more preferred feature extraction strategies. For example, a terrorism financing vector may call for geo temporal sequence features and entity relationship features, while a synthetic identity vector may emphasize device fingerprinting and identity consistency features. From this mapping the system calculates the specific feature extraction process that should be applied, including the set of input fields to transform, the aggregation windows, and the statistical or graph-based metrics to compute. It then scans the catalog of available processing routines to find a routine that implements this calculated process or that is tagged as supporting the required feature family. That routine is selected as the first processing routine for the interaction, and when executed it derives the specialized features that will feed downstream scoring and severity assessment tailored to the potential threat vector.

In some embodiments, the system may select the first processing routine from the plurality of processing routines by calculating a baseline data comparison corresponding to the potential threat vector and comparing the point-of-contact characteristic to the baseline data comparison. The system may select the first processing routine by defining a baseline data comparison tailored to the potential threat vector and then determining how the point of contact characteristic deviates from that baseline. After the potential threat vector has been identified, the system consults configuration stores or learned models to obtain baseline distributions, profiles, or threshold tables that describe normal behavior for that vector, for example typical transaction sizes, usual geospatial movement patterns, or standard interaction frequencies for the relevant business type and geography. This baseline data comparison specifies what constitutes expected values for the point of contact characteristic under benign conditions. The system evaluates the current characteristic against this baseline, computing deviation metrics such as z scores, percentile positions, or categorical distance. Depending on the magnitude and direction of the deviation, routing rules then choose one of several processing routines from the catalog. Minor deviations may route the data through a lightweight normalization or logging routine, while significant departures from the baseline may trigger a more intensive anomaly detection or pattern mining routine. The routine selected in this manner becomes the first processing routine applied to the point of contact data, ensuring that computational effort scales with how unusual the interaction appears relative to the baseline appropriate for the potential threat vector.

In some embodiments, the system may select the first data retrieval routine from the plurality of data retrieval routines for the point-of-contact data by calculating a siloed dataset corresponding to the potential threat vector and comparing the point-of-contact characteristic to the siloed dataset. The system may select the first data retrieval routine by identifying which siloed dataset is most relevant to the potential threat vector and then determining whether the point of contact characteristic warrants querying that dataset. Once a potential threat vector has been assigned, the system consults a configuration that links each vector to one or more siloed datasets, such as regional mobility logs, sector specific fraud archives, sanctions and watchlist repositories, or cross institution identity records. For the current vector, it calculates which dataset or datasets could provide the most discriminative information, effectively defining a candidate siloed dataset for enrichment. The system then compares the point of contact characteristic to summary descriptors or access rules associated with that dataset, for example checking whether the geography falls within a region covered by a mobility feed, whether the business type is one that has historical fraud patterns in a sector archive, or whether the entity role qualifies for cross institution identity checks. If the comparison indicates that the dataset is pertinent, the routing logic selects the retrieval routine that encapsulates how to query that dataset, including necessary filters and privacy controls. This routine becomes the first data retrieval routine executed for the point of contact data, pulling in only the most contextually relevant external information to refine anomaly detection and severity assessment.

In some embodiments, the system may select the first data retrieval routine from the plurality of data retrieval routines for the point-of-contact data by filtering the plurality of processing routines and/or the plurality of data retrieval routines and on the point-of-contact characteristic to generate a filtered subset and ranking the filtered subset. The system may select the first data retrieval routine by using the point of contact characteristic to filter and rank the available routines before choosing one for execution. After the characteristic is calculated, the system evaluates each member of the processing and retrieval catalogs against routing rules or metadata tags that describe when a routine is applicable, such as required channel, geography range, business type, or threat vector category. Routines whose applicability conditions do not match the current point of contact characteristics are excluded, leaving a filtered subset that is contextually relevant to the interaction. For each routine in this subset, the system then computes a priority score that can incorporate factors such as expected informational value for the current potential threat vector, historical detection performance, latency and cost budgets, and diversity relative to other selected routines. The routines are ranked according to these scores, and the highest ranked retrieval oriented routine within the subset is chosen as the first data retrieval routine for the point of contact data. By filtering on the characteristic and then ranking candidates instead of selecting blindly, the system ensures that the chosen retrieval routine provides the greatest marginal value for anomaly detection while respecting operational constraints.

At step 610, process 600 (e.g., using one or more components described above) processes the point-of-contact data with the routine. For example, the system may process the point-of-contact data using the one or more processing routines or the one or more data retrieval routines to generate one or more outputs. The system may process the point of contact data by executing the selected processing and data retrieval routines and aggregating their results into structured outputs. Once routing has identified which routines are applicable for the interaction, the point of contact record is passed through each processing routine in turn or in parallel. These routines can perform actions such as data cleansing, normalization, feature extraction, anomaly scoring, pattern matching against typologies, graph construction, or behavioral profiling. In parallel, any selected data retrieval routines issue targeted queries to internal repositories or external networks, returning information such as historical transaction summaries, watchlist hits, cross border travel history, device reputation scores, or cross institution identity linkages. Each routine writes its results into an output structure associated with the interaction, which may include numerical scores, categorical flags, enriched attributes, or explanatory indicators describing which conditions were met. After all routines are complete, the system consolidates these individual results into one or more outputs that summarize the enriched view of the point of contact, providing downstream components with the evidence needed for threat vector severity calculation, alert generation, and operator display.

In some embodiments, the system may calculate a plurality of domains for the point-of-contact data, calculate respective weighted outputs corresponding to each of the plurality of domains, and process each respective output in a fusion layer to harmonize the respective weighted outputs. The system may calculate a plurality of domains for the point of contact data by partitioning the analysis space into distinct perspectives such as financial behavior, geospatial movement, device integrity, identity consistency, and network relationships. For a given interaction, domain assignment logic evaluates which of these perspectives are relevant based on the point of contact characteristics and potential threat vector, and for each active domain it routes the data through specialized processing and retrieval routines. These domain specific pipelines produce outputs such as anomaly scores, pattern match indicators, or risk metrics that are calibrated within their own domain. The system then applies weighting functions to each domain output, where the weights reflect factors like domain reliability for the current context, historical predictive power for the associated threat vector, and the confidence of the underlying models. This produces a set of weighted outputs, one per domain. A fusion layer receives these weighted outputs and processes them jointly to harmonize the evidence, for example by normalizing scales, resolving conflicts between domains, and aggregating them into a unified risk representation. The fusion logic can include techniques such as weighted averaging, ensemble scoring, rule based overrides, or learned fusion models that account for interactions between domains. The final fused result provides a coherent view of risk that integrates complementary signals from all relevant domains while avoiding double counting or inconsistency.

At step 612, process 600 (e.g., using one or more components described above) generates a characteristic for the potential threat vector. For example, the system may generate a second characteristic for the potential threat vector by modifying the first characteristic based on processing the point-of-contact data using the first processing routine or the first data retrieval routine. The system may generate a second characteristic for the potential threat vector by updating the initial assessment encoded in the first characteristic with new evidence produced by the selected routines. After the first processing routine or first data retrieval routine runs on the point of contact data, it produces one or more outputs such as anomaly scores, matches to known patterns, or enriched contextual attributes. The system interprets these outputs using transformation rules or scoring models that specify how strongly each type of result should influence the threat evaluation. For example, a high anomaly score or a confirmed watchlist hit may carry a large positive adjustment, while benign matching to normal baselines may reduce perceived risk. These adjustments are applied to the first characteristic, which may be an initial severity score, risk tier, or coded label, to compute an updated value. The result of this modification is stored as the second characteristic for the potential threat vector, representing a refined severity level that incorporates both the original location and category context and the additional insight obtained from the first processing or retrieval step.

In some embodiments, the system may generate the second characteristic for the potential threat vector by modifying the first characteristic based on processing the point-of-contact data using the first processing routine or the first data retrieval routine by calculating an initial severity characteristic corresponding to the first characteristic, generating a final severity characteristic for the potential threat vector by modifying the initial severity characteristic, and calculating the second characteristic based on the final severity characteristic. The system may generate the second characteristic for the potential threat vector by explicitly tracking how routine outputs refine severity relative to the first characteristic. After the potential threat vector is created and assigned the first characteristic, the system translates that characteristic into an initial severity characteristic, such as a numeric baseline risk score or tier that encodes the prior expectation of threat given the location and category context. The point of contact data is then processed using the first processing routine or the first data retrieval routine, which yields outputs like anomaly indicators, similarity scores to known typologies, or external match results. Using weighting rules or fusion logic, the system modifies the initial severity characteristic in light of these outputs, increasing it when strong or corroborated risk signals appear and decreasing it when evidence supports normal behavior or contradicts the initial concern. This adjusted value is stored as the final severity characteristic for the potential threat vector. The system then derives the second characteristic from this final severity characteristic, for example by mapping the final severity score into a refined risk tier, alert priority, or coded label. In this way the second characteristic encapsulates the fully updated evaluation of the potential threat vector after the first round of targeted processing and data retrieval.

At step 614, process 600 (e.g., using one or more components described above) generates the potential threat vector with the characteristic. For example, the system may generate for display, on a user interface, the potential threat vector with the second characteristic. The system may generate for display on a user interface the potential threat vector with the second characteristic by transforming the internal representation of the vector into a visual alert or panel tailored to the operator’s workflow. After the second characteristic has been computed, the system assembles a presentation object that includes the threat vector’s identifier, category, relevant point of contact attributes, and the refined severity encoded in the second characteristic, such as a risk tier, priority label, or color signature. Formatting rules determine how these elements appear, for example placing the threat label as a title, rendering the severity as a prominently colored badge or score, and listing key contextual fields like location, channel, and timestamp in supporting text. The user interface layer then renders this object in the appropriate view, such as an alert queue, transaction detail pane, or real time monitoring dashboard, ensuring that the second characteristic governs visual prominence, sort order, and any attention-grabbing cues like highlighting or icons. In this way an operator at the terminal sees not only that a potential threat vector has been detected but also its updated severity, enabling informed, timely decisions without needing to inspect the underlying analytics.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 6.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for data scraping and/or data collection of encrypted and/or obfuscated content sources or for detecting anomalies in siloed networks featuring extreme signal-to-noise imbalances using point-of-contact based filtering criteria for data processing and data retrieval.

2. The method of the previous embodiment, further comprising: retrieving a first content source, wherein the first content source comprises a plurality of encrypted content masked by one or more of a plurality of data encryption types; executing a first routine, of a bifurcated data extraction routine, on the first content source to determine a first data encryption type for first encrypted content in the first content source; executing a second routine, of the bifurcated data extraction routine, to select a first extraction function, from a plurality of extraction functions, based on the first data encryption type; generating first non-encrypted content based on applying the first extraction function to the first encrypted content; and generating for display, on a user interface, the first non-encrypted content.

3. The method of any one of the preceding embodiments, wherein retrieving the first content source further comprises: initiating a secured session for extracting data from the first content source; and recording a first state for the first content source corresponding to the secured session, wherein the first non-encrypted content is archived based on the first state.

4. The method of any one of the preceding embodiments, wherein retrieving the first content source further comprises: receiving a first user request to begin a secured session; and authenticating the secured session based on the first user request.

5. The method of any one of the preceding embodiments, wherein executing the first routine on the first content source to determine the first data encryption type for the first encrypted content in the first content source further comprises: determining a plurality of content subsets at the first content source; iteratively parsing code on each of the plurality of content subsets to extract first encrypted content from the first content source; and determining dependencies between each of the plurality of content subsets based on the first encrypted content.

6. The method of any one of the preceding embodiments, wherein executing the first routine on the first content source to determine the first data encryption type for the first encrypted content in the first content source further comprises: identifying a plurality of data elements in the first content source; determining one or more data encryption type indicia that correspond to one or more of the plurality of data elements; and comparing the one or more data encryption type indicia to a plurality of data encryption types to determine that the one or more data encryption type indicia correspond to the first data encryption type.

7. The method of any one of the preceding embodiments, wherein executing the first routine on the first content source to determine the first data encryption type for the first encrypted content in the first content source further comprises: determining a first location of the first data encryption type; and determining a first encryption mapping of the first content source based on determining that the first location corresponds to the first data encryption type.

8. The method of any one of the preceding embodiments, wherein the first data encryption type comprises a nested attribute, and wherein applying the first extraction function to the first encrypted content comprises: determining a series of operations to perform on a plurality of text strings of the nested attribute; and extracting a first text string of the plurality of text strings based on the series of operations.

9. The method of any one of the preceding embodiments, wherein the first data encryption type comprises an image, and wherein applying the first extraction function to the first encrypted content comprises: determining text data in the image; and extracting the text data from the image.

10. The method of any one of the preceding embodiments, wherein the first data encryption type comprises a style element of the first encrypted content, and wherein applying the first extraction function to the first encrypted content comprises: determining metadata corresponding to the style element; formatting the metadata into a data variable; and extracting the data variable.

11. The method of any one of the preceding embodiments, wherein generating the first non-encrypted content based on applying the first extraction function to the first encrypted content further comprises: receiving a first data output from the first extraction function; and formatting the first data output into a tabular representation to generate the first non-encrypted content.

12. The method of any one of the preceding embodiments, wherein generating the first non-encrypted content based on applying the first extraction function to the first encrypted content further comprises: receiving a first data output from the first extraction function, wherein the first data output comprises an address; and formatting the first data output, using an address cleansing algorithm, to populate a standardized address field with the address.

13. The method of any one of the preceding embodiments, wherein generating the first non-encrypted content based on applying the first extraction function to the first encrypted content further comprises: receiving a first data output from the first extraction function, wherein the first data output comprises pixel width metadata; and determining a numeric score based on the pixel width metadata.

14. The method of any one of the preceding embodiments, wherein generating the first non-encrypted content based on applying the first extraction function to the first encrypted content further comprises: receiving a first data output from the first extraction function, wherein the first data output comprises a first date format; and reformatting the first data output to a second date format.

15. The method of any one of the preceding embodiments, wherein generating the first non-encrypted content based on applying the first extraction function to the first encrypted content further comprises: receiving a first data output from the first extraction function, wherein the first data output comprises a longitude or a latitude; and determining a geospatial coordinate based on the longitude or the latitude.

16. The method of any one of the preceding embodiments, wherein generating for display the first non-encrypted content further comprises: parsing the first non-encrypted content for a plurality of data elements that correspond to encrypted content; and determining whether to process the first non-encrypted content with the bifurcated data extraction routine based on the plurality of data elements.

17. The method of any one of the preceding embodiments, further comprising: receiving point-of-contact data at a first location; calculating a potential threat vector based on the first location, wherein the potential threat vector has a first characteristic; calculating a point-of-contact characteristic in the point-of-contact data; based on the point-of-contact characteristic, selecting a first processing routine, from a plurality of processing routines, or a first data retrieval routine, from a plurality of data retrieval routines, for the point-of-contact data; processing the point-of-contact data using the first processing routine or the first data retrieval routine; generating a second characteristic for the potential threat vector by modifying the first characteristic based on processing the point-of-contact data using the first processing routine or the first data retrieval routine; and generating for display, on a user interface, the potential threat vector with the second characteristic.

18. The method of any one of the preceding embodiments, wherein receiving the point-of-contact data at the first location further comprises: receiving a user input into a user terminal at the first location; and calculating the point-of-contact data based on the user input.

19. The method of any one of the preceding embodiments, wherein calculating the potential threat vector based on the first location further comprises: calculating a location identifier corresponding to the first location; and comparing the location identifier to a plurality of potential threat vector.

20. The method of any one of the preceding embodiments, wherein the first characteristic is determined by: calculating threat vector category for the potential threat vector; and calculating the first characteristic based on the threat vector category.

21. The method of any one of the preceding embodiments, wherein the first characteristic is determined by: comparing the potential threat vector to a predetermined set of identifiers, wherein each of the predetermined set of identifiers corresponds to a respective potential threat vector; calculating an identifier corresponding to the potential threat vector based on comparing the potential threat vector to the predetermined set of identifiers, wherein the identifier comprises an alpha-numeric code.

22. The method of any one of the preceding embodiments, wherein the first characteristic is determined by: calculating a graphical characteristic corresponding to the identifier; and using the graphical characteristic to determine the first characteristic.

23. The method of any one of the preceding embodiments, wherein the first characteristic is determined by: normalizing the point-of-contact data based on the first location to generate normalized point-of-contact data; and calculating an identifier corresponding to the normalized point-of-contact data.

24. The method of any one of the preceding embodiments, wherein the first characteristic is determined by: comparing the point-of-contact data to a coded taxonomy; and determining the first characteristic based on comparing the point-of-contact data to the coded taxonomy.

25. The method of any one of the preceding embodiments, wherein the first characteristic is determined by: processing the point-of-contact data for personally identifiable information; and masking the personally identifiable information in the point-of-contact data.

26. The method of any one of the preceding embodiments, wherein the first characteristic is determined by: selecting the potential threat vector from a plurality of potential threat vectors for the first location; calculating a first geographic position and first location type corresponding to the first location; and calculating an initial severity characteristic based on the first geographic position and the first location type.

27. The method of any one of the preceding embodiments, wherein calculating the point-of-contact characteristic in the point-of-contact data further comprises: parsing the point-of-contact data for a user input; and modifying the user input based on the first location to calculate the point-of-contact characteristic.

28. The method of any one of the preceding embodiments, wherein selecting the first processing routine from the plurality of processing routines further comprises: calculating a feature-extraction process corresponding to the potential threat vector; and implementing the feature-extraction process in the first processing routine.

29. The method of any one of the preceding embodiments, wherein selecting the first processing routine from the plurality of processing routines further comprises: calculating a baseline data comparison corresponding to the potential threat vector; and comparing the point-of-contact characteristic to the baseline data comparison.

30. The method of any one of the preceding embodiments, wherein selecting the first data retrieval routine from the plurality of data retrieval routines for the point-of-contact data further comprises: calculating a siloed dataset corresponding to the potential threat vector; and comparing the point-of-contact characteristic to the siloed dataset.

31. The method of any one of the preceding embodiments, wherein selecting the first data retrieval routine from the plurality of data retrieval routines for the point-of-contact data further comprises: filtering the plurality of processing routines and/or the plurality of data retrieval routines and on the point-of-contact characteristic to generate a filtered subset; and ranking the filtered subset.

32. The method of any one of the preceding embodiments, wherein processing the point-of-contact data using the first processing routine or the first data retrieval routine further comprises: calculating a plurality of domains for the point-of-contact data; calculating respective weighted outputs corresponding to each of the plurality of domains; and processing each respective output in a fusion layer to harmonize the respective weighted outputs.

33. The method of any one of the preceding embodiments, wherein generating the second characteristic for the potential threat vector by modifying the first characteristic based on processing the point-of-contact data using the first processing routine or the first data retrieval routine further comprises: calculating an initial severity characteristic corresponding to the first characteristic; generating a final severity characteristic for the potential threat vector by modifying the initial severity characteristic; and calculating the second characteristic based on the final severity characteristic.

34. One or more non-transitory, computer-readable mediums storing instructions that, when executed by a data processing apparatus, cause the data processing apparatus to perform operations comprising those of any of embodiments 1-33.

35. A system comprising one or more processors; and memory storing instructions that, when executed by the processors, cause the processors to effectuate operations comprising those of any of embodiments 1-33.

36. A system comprising means for performing any of embodiments 1-33.

What is claimed is:

1. A system for detecting anomalies in siloed networks featuring extreme signal-to-noise imbalances using point-of-contact based filtering criteria for data processing and data retrieval the system comprising: one or more processors; and one or more non-transitory, computer-readable mediums comprising instructions that when executed by the one or more processors cause operations comprising: receiving, via a user terminal, point-of-contact data at a first location, wherein the first location corresponds to a first geographic position and a first location type; selecting a potential threat vector from a plurality of potential threat vectors for the first location, wherein the potential threat vector has an initial severity characteristic calculated based on the first geographic position and the first location type; calculating a point-of-contact characteristic in the point-of-contact data; based on the point-of-contact characteristic, selecting one or more processing routines, from a plurality of processing routines, or one or more data retrieval routines, from a plurality of data retrieval routines, for the point-of-contact data; processing the point-of-contact data using the one or more processing routines or the one or more data retrieval routines to generate one or more outputs; generating a final severity characteristic for the potential threat vector by modifying the initial severity characteristic by weighting the one or more outputs; and generating for display, at the user terminal, a dynamic threat identifier for the potential threat vector, wherein the dynamic threat identifier is generated for display with the final severity characteristic.

2. A method for detecting anomalies in siloed networks featuring extreme signal-to-noise imbalances using point-of-contact based filtering criteria for data processing and data retrieval, the method comprising:receiving point-of-contact data at a first location;calculating a potential threat vector based on the first location, wherein the potential threat vector has a first characteristic;calculating a point-of-contact characteristic in the point-of-contact data;based on the point-of-contact characteristic, selecting a first processing routine, from a plurality of processing routines, or a first data retrieval routine, from a plurality of data retrieval routines, for the point-of-contact data;processing the point-of-contact data using the first processing routine or the first data retrieval routine;generating a second characteristic for the potential threat vector by modifying the first characteristic based on processing the point-of-contact data using the first processing routine or the first data retrieval routine; andgenerating for display, on a user interface, the potential threat vector with the second characteristic.

3. The method of claim 2, wherein receiving the point-of-contact data at the first location further comprises:receiving a user input into a user terminal at the first location; and calculating the point-of-contact data based on the user input.

4. The method of claim 2, wherein calculating the potential threat vector based on the first location further comprises:calculating a location identifier corresponding to the first location; and comparing the location identifier to a plurality of potential threat vector.

5. The method of claim 2, wherein the first characteristic is determined by: calculating threat vector category for the potential threat vector; and calculating the first characteristic based on the threat vector category.

6. The method of claim 2, wherein the first characteristic is determined by: comparing the potential threat vector to a predetermined set of identifiers, wherein each of the predetermined set of identifiers corresponds to a respective potential threat vector; and calculating an identifier corresponding to the potential threat vector based on comparing the potential threat vector to the predetermined set of identifiers, wherein the identifier comprises an alpha-numeric code.

7. The method of claim 6, wherein the first characteristic is determined by: calculating a graphical characteristic corresponding to the identifier; and using the graphical characteristic to determine the first characteristic.

8. The method of claim 2, wherein the first characteristic is determined by: normalizing the point-of-contact data based on the first location to generate normalized point-of-contact data; and calculating an identifier corresponding to the normalized point-of-contact data.

9. The method of claim 2, wherein the first characteristic is determined by: comparing the point-of-contact data to a coded taxonomy; and determining the first characteristic based on comparing the point-of-contact data to the coded taxonomy.

10. The method of claim 2, wherein the first characteristic is determined by: processing the point-of-contact data for personally identifiable information; andmasking the personally identifiable information in the point-of-contact data.

11. The method of claim 2, wherein the first characteristic is determined by: selecting the potential threat vector from a plurality of potential threat vectors for the first location; calculating a first geographic position and first location type corresponding to the first location; and calculating an initial severity characteristic based on the first geographic position and the first location type.

12. The method of claim 2, wherein calculating the point-of-contact characteristic in the point-of-contact data further comprises: parsing the point-of-contact data for a user input; and modifying the user input based on the first location to calculate the point-of-contact characteristic.

13. The method of claim 2, wherein selecting the first processing routine from the plurality of processing routines further comprises: calculating a feature-extraction process corresponding to the potential threat vector; and implementing the feature-extraction process in the first processing routine.

14. The method of claim 2, wherein selecting the first processing routine from the plurality of processing routines further comprises: calculating a baseline data comparison corresponding to the potential threat vector; and comparing the point-of-contact characteristic to the baseline data comparison.

15. The method of claim 2, wherein selecting the first data retrieval routine from the plurality of data retrieval routines for the point-of-contact data further comprises: calculating a siloed dataset corresponding to the potential threat vector; and comparing the point-of-contact characteristic to the siloed dataset.

16. The method of claim 2, wherein selecting the first data retrieval routine from the plurality of data retrieval routines for the point-of-contact data further comprises: filtering the plurality of processing routines and/or the plurality of data retrieval routines and on the point-of-contact characteristic to generate a filtered subset; and ranking the filtered subset.

17. The method of claim 2, wherein processing the point-of-contact data using the first processing routine or the first data retrieval routine further comprises: calculating a plurality of domains for the point-of-contact data; calculating respective weighted outputs corresponding to each of the plurality of domains; and processing each respective output in a fusion layer to harmonize the respective weighted outputs.

18. The method of claim 2, wherein generating the second characteristic for the potential threat vector by modifying the first characteristic based on processing the point-of-contact data using the first processing routine or the first data retrieval routine further comprises: calculating an initial severity characteristic corresponding to the first characteristic; generating a final severity characteristic for the potential threat vector by modifying the initial severity characteristic; andcalculating the second characteristic based on the final severity characteristic.

19. One or more non-transitory, computer-readable media comprising instructions that when executed by one or more processors cause operations comprising: receiving point-of-contact data at a first location; calculating a point-of-contact characteristic in the point-of-contact data; based on the point-of-contact characteristic, selecting a first processing routine, from a plurality of processing routines, or a first data retrieval routine, from a plurality of data retrieval routines, for the point-of-contact data; processing the point-of-contact data using the first processing routine or the first data retrieval routine; calculating a dynamic threat identifier for a potential threat vector based on processing the point-of-contact data using the first processing routine or the first data retrieval routine; and generating for display, on a user interface, the dynamic threat identifier for the potential threat vector.

20. The one or more non-transitory, computer-readable media of claim 19, wherein calculating the dynamic threat identifier further comprises: calculating a standardized classification corresponding to the potential threat vector; and generating for display an alpha-numeric code corresponding to the standardized classification.
